(19) United States
(12) Patent Application Publication
(10) Pub. No.: US 2022/0255118 A1
(43) Pub. Date: Aug. 11, 2022

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Hiroshi ISOJIMA, Kanagawa (JP); Hideyuki SUZUKI, Kanagawa (JP)

(73) Assignee: FUJIFILM Corporation, Tokyo (JP)

(21) Appl. No.: 17/725,525

(22) Filed: Apr. 20, 2022

Related U.S. Application Data
(63) Continuation of application No. PCT/JP2020/038701, filed on Oct. 14, 2020.

(30) Foreign Application Priority Data
Nov. 18, 2019 (JP) 2019-207742

(51) Int. Cl. H01M 10/056; H01M 10/0525; H01M 4/04

(52) U.S. Cl. CPC H01M 10/056; H01M 2004/021; H01M 4/0407; H01M 10/0525

(57) ABSTRACT

An inorganic solid electrolyte-containing composition contains an inorganic solid electrolyte and a polymer binder, in which the polymer binder includes at least two polymer binders A and B different from each other, the polymer binder A has a particulate shape, and the polymer binder B is a polymer binder consisting of a polymer having a crystallization temperature of 60° C. or higher.

### CROSS-REFERENCE TO RELATED APPLICATIONS

This application is a Continuation of PCT International Application No. PCT/JP2020/038701 filed on Oct. 14, 2020, which claims priority under 35 U.S.C § 119(a) to Japanese Patent Application No. 2019-207742 filed on Nov. 18, 2019. Each of the above application(s) is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary can improve safety and reliability, which are said to be problems to be solved in a battery in which an organic electrolytic solution is used. It is also said to be capable of extending the battery life. Furthermore, all-solid state secondary batteries can be provided with a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In such an all-solid state secondary battery, it has been proposed to form any layer of the constitutional layers (an inorganic solid electrolyte layer, a negative electrode active material layer, a positive electrode active material layer, and the like) with a material (a constitutional layer forming material) containing an inorganic solid electrolyte or an active material and containing a binder (a binding agent). For example, JP6262503B discloses a solid electrolyte mixed solution containing a solid electrolyte, a first binding agent insoluble in a non-polar solvent, and a second binding agent soluble in a non-polar solvent, in which an SP value of the first binding agent is different from that of the second binding agent.

### SUMMARY OF THE INVENTION

A constitutional layer of an all-solid state secondary battery is formed of solid particles (an inorganic solid electrolyte, an active material, a conductive auxiliary agent, and the like), and thus the interfacial contact state between the solid particles is generally insufficient and the interfacial resistance tends to be high. In addition, the binding force between the solid particles is not sufficient. In a case where the binding force is insufficient, charging and discharging of the all-solid state secondary battery (intercalation and deintercalation of metal ions of the active material) causes poor binding between solid particles (generation of voids), which inevitably decreases battery performance (for example, cycle characteristics).

In order to solve such problems, a combined use of a polymer binder with solid particles has been studied as in JP6262503B. However, since the polymer binder generally does not have an ion conductivity, the resistance of the all-solid state secondary battery using the polymer binder is further increased in response to the above-described high interfacial resistance between the solid particles, and the battery performance (the battery voltage) drops. In particular, in a case where the using amount thereof is increased in order to strengthen the binding force of the solid particles, and in a case where the polymer binder is caused to continuously present between the solid particles as in JP6262503B, the increase in resistance becomes remarkable. As described above, in a case where the solid particles and the polymer binder are used in combination, there is a trade-off relationship between the enhancement of the binding property of the solid particles and the reduction of the interfacial resistance (the suppression of the increase in interfacial resistance), which is desired to be overcome.

In recent years, research and development for improving the performance and the practical application of electric vehicles have progressed rapidly, and the demand for battery performance required for all-solid state secondary batteries has become higher. In order to meet this demand, it is required to develop a constitutional layer forming material that achieves both enhancement of the binding property of the solid particles and the reduction of the interfacial resistance at a higher level. However, the solid electrolyte composition disclosed in JP6262503B does not describe this viewpoint.

An object of the present invention is to provide an inorganic solid electrolyte-containing composition that is capable of realizing a constitutional layer in which solid particles are firmly bound to each other while suppressing an increase in interfacial resistance, by using the inorganic solid electrolyte-containing composition as a constitutional layer forming material of an all-solid state secondary battery. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of various studies on the binding state of the polymer binder that is used in combination with the inorganic solid electrolyte, the inventors of the present invention found that the crystallinity of the polymer that forms the polymer binder, which has not been paid attention to in the related art, can improve the contact state (the contact area) between solid particles and the binding force in a well-balanced manner in a case where the solid particles are bound to each other. Based on this finding, the inventors of the present invention carried out further studies, and as a result, have found that in a case where an inorganic solid electrolyte-containing composition in which two or more different polymer binders are used in combination for the inorganic solid electrolyte, where at least one polymer binder is formed of a crystalline polymer having a crystallization temperature of 60° C. or higher and the other polymer binder has a particulate shape, is used as a constitutional layer forming material of an all-solid state secondary battery, it is possible to realize a constitutional layer in which solid particles are firmly bound to each other while sufficiently ensuring interfacial contact state between the solid particles. Further, it has been found that in a case of employing this constitutional layer formed of the inorganic solid electrolyte-containing composition as a constitutional layer of a sheet for an all-solid state secondary battery or a constitutional layer of an all-solid state secondary battery, it is possible to further improve the lower resistance of the battery resistance and the battery performance (cycle characteristics) of the all-solid state secondary battery. The present invention has been completed through further studies based on these findings.

That is, the above problems have been solved by the following means.

<1> An inorganic solid electrolyte-containing composition comprising:

an inorganic solid electrolyte having an ion conductivity of a metal belonging to Group 1 or Group 2 in the periodic table; and

a polymer binder,

wherein the polymer binder includes at least two polymer binders A and B different from each other, where the polymer binder A has a particulate shape, and the polymer binder B is a polymer binder consisting of a polymer having a crystallization temperature of 60° C. or higher.

<2> The inorganic solid electrolyte-containing composition according to <1>, further comprising a dispersion medium.

<3> The inorganic solid electrolyte-containing composition according to <2>, in which the dispersion medium is a non-polar dispersion medium.

<4> The inorganic solid electrolyte-containing composition according to <3>, in which a solubility of the polymer binder B in the non-polar dispersion medium is 2% by mass or more.

<5> The inorganic solid electrolyte-containing composition according to <3> or <4>, in which a solubility of the binder polymer binder A in a non-polar dispersion medium is 1% by mass or less.

<6> The inorganic solid electrolyte-containing composition according to any one of <1> to<5>, in which a polymer that forms the polymer binder B is a fluorine-based polymer, a hydrocarbon-based polymer, polyurethane, or a (meth)acrylic polymer.

<7> The inorganic solid electrolyte-containing composition according to any one of <1> to <6>, in which a polymer that forms the polymer binder A is polyurethane or a (meth)acrylic polymer.

<8> The inorganic solid electrolyte-containing composition according to any one of <1> to <7>, further comprising an active material.

<9> The inorganic solid electrolyte-containing composition according to <8>, in which a peel strength of the polymer binder B with respect to a collector is 0.1 N/mm or more.

<10> A sheet for an all-solid state secondary battery, comprising a layer formed of the inorganic solid electrolyte-containing composition according to any one of <1> to <9>.

<11> The sheet for an all-solid state secondary battery according to <10>, in which the layer constituted of the inorganic solid electrolyte-containing composition is a heat-dried product of the inorganic solid electrolyte-containing composition at a temperature equal to or higher than the crystallization temperature of the polymer binder B.

<12> The sheet for an all-solid state secondary battery according to <10> or <11>, in which the layer constituted of the inorganic solid electrolyte-containing composition contains 30 or more particulate regions derived from the polymer binder, in a cross-sectional region of 10 μm².

<13> An all-solid state secondary battery comprising, in the following order, a positive electrode active material layer; a solid electrolyte layer; and a negative electrode active material layer,

in which at least one of the positive electrode active material layer, the solid electrolyte layer, or the negative electrode active material layer is a layer formed of the inorganic solid electrolyte-containing composition according to any one of <1> to <9>.

<14> A manufacturing method for a sheet for an all-solid state secondary battery, the manufacturing method comprising forming a film by using the inorganic solid electrolyte-containing composition according to any one of <1> to <9> to film formation.

<15> The manufacturing method for a sheet for an all-solid state secondary battery according to <14>,

in which the inorganic solid electrolyte-containing composition is heated at a temperature equal to or higher than the crystallization temperature of the polymer binder B.

<16> A manufacturing method for an all-solid state secondary battery comprising the manufacturing method for a sheet for an all-solid state secondary battery according to <14> or <15>.

According to the inorganic solid electrolyte-containing composition according to an aspect of the present invention, it is possible to realize a constitutional layer in which solid particles are firmly bound to each other while suppressing an increase in interfacial resistance, by using the inorganic solid electrolyte-containing composition as a constitutional layer forming material of an all-solid state secondary battery. Further, in a case where the sheet for an all-solid state secondary battery according to an aspect of the present invention is used as a constitutional layer of an all-solid state secondary battery, it is possible to realize an all-solid state secondary battery that exhibits the lower resistance of the battery resistance and the excellent battery performance (cycle characteristics). Further, the all-solid state secondary battery according to an aspect of the present invention exhibits lower resistance and excellent battery performance (cycle characteristics).

According to each of the manufacturing methods for a sheet for an all-solid state secondary battery and an all-solid state secondary battery according to an aspect of the present invention, it is possible to manufacture a sheet for an all-solid state secondary battery and an all-solid state secondary battery, which exhibit the above-described excellent characteristics.

### BRIEF DESCRIPTION OF THE DRAWINGS

FIG. 1 is a vertical cross-sectional view schematically illustrating an all-solid state secondary battery according to a preferred embodiment of the present invention.

### DESCRIPTION OF THE PREFERRED EMBODIMENTS

In the present specification, numerical ranges expressed using “to” include numerical values before and after the “to” as the lower limit value and the upper limit value.

In the present specification, the expression of a compound (for example, in a case where a compound is represented by an expression with “compound” added to the end) refers to not only the compound itself but also a salt or an ion thereof. In addition, this expression also refers to a derivative obtained by modifying a part of the compound, for example, by introducing a substituent into the compound within a range where the effects of the present invention are not impaired.

In the present invention, (meth)acryl means one or both of acryl and methacryl. The same applies to (meth)acrylate.

A substituent, a linking group, or the like (hereinafter, referred to as “substituent or the like”) is not specified in the present specification regarding whether to be substituted or unsubstituted may have an appropriate substituent. Accordingly, even in a case where a YYY group is simply described in the present specification, this YYY group includes not only an aspect having a substituent but also an aspect not having a substituent. The same shall be applied to a compound that is not specified in the present specification regarding whether to be substituted or unsubstituted. Examples of the preferred examples of the substituent include a substituent Z described below.

In the present specification, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

### Inorganic Solid Electrolyte-Containing Composition

The inorganic solid electrolyte-containing composition according to the embodiment of the present invention contains an inorganic solid electrolyte having an ion conductivity of a metal belonging to Group 1 or Group 2 in the periodic table, and a polymer binder.

The inorganic solid electrolyte-containing composition according to the embodiment of the present invention contains, as polymer binders, at least two polymer binders A and B which are different from each other. A particulate polymer binder is employed as the polymer binder A, and a polymer binder consisting of a polymer having a crystallization temperature of 60° C. or higher is employed as the polymer binder B.

In the present invention, the description that the polymer binder A and the polymer binder B are different from each other means that the chemical structures or properties of the two polymer binders are different from each other, and it suffices that one polymer binder has a particulate shape in the inorganic solid electrolyte-containing composition and the other polymer binder consists of a crystalline polymer. For example, the combination of the polymer binders A and B includes a combination of particulate polymer binders consisting of crystalline polymers that differ in polymer kind and composition.

The polymer binder contained in the inorganic solid electrolyte-containing composition according to the embodiment of the present invention firmly binds solid particles to each other while suppressing an increase in interfacial resistance, at least in the solid electrolyte layer formed of the inorganic solid electrolyte-containing composition and furthermore, and functions as a binding agent that binds a collector to the solid particle in some cases. In addition, the polymer binder may have or may not have a function of binding solid particles to each other (for example, binding inorganic solid electrolytes to each other, binding an inorganic solid electrolyte to an active material, or binding active materials to each other), such as an inorganic solid electrolyte (additionally, an active material, a conductive auxiliary agent, or the like, which can be present together) in the inorganic solid electrolyte-containing composition, and it also has a function of dispersing solid particles in the dispersion medium in some cases.

According to the inorganic solid electrolyte-containing composition according to the embodiment of the present invention, it is possible to form a constitutional layer in which solid particles are firmly bound while suppressing an increase in interfacial resistance. A sheet for an all-solid state secondary battery and an all-solid state secondary battery, having such a constitutional layer, can achieve both the lower resistance of the battery resistance and the cycle characteristics at a higher level.

Although the details of the reason for the above effects are not yet clear, they are conceived to be as follows. That is, it is conceived that the polymer binder B formed of a crystalline polymer having a crystallization temperature of 60° C. or higher binds the solid particles to each other by the crystalline component interacting with the solid particles (for example, van der Waals interaction). On the other hand, the non-crystalline component (the soluble component) contained in the polymer that forms the polymer binder B becomes a factor that causes an increase in interfacial resistance in a case where the surface of the solid particles is coated. However, in the present invention, since the polymer binder B is combined with the particulate polymer binder (a part of the polymer binder B is replaced with the polymer binder A), it is conceived that the surface coating amount of solid particles due to both polymer binders can be reduced without impairing the firm binding between the solid particles.

It is conceived that due to such action of both polymer binders, it is possible to firmly bind solid particles to each other while suppressing an increase in interfacial resistance, and it is possible to achieve both the lower resistance and the cycle characteristics of the all-solid state secondary battery at a further higher level.

In particular, in a case where the crystalline component of the polymer binder B which is used in combination with the polymer binder A is once melted in the process of forming the constitutional layer and then recrystallized, it is conceived that it is possible to further firmly binds solid particles to each other, and the volume of the polymer binder with which the surface of the solid particles is coated contracts as the recrystallization of the solid particles progress, whereby the coating amount decreases and the interfacial contact between the solid particles can be ensured. As a result, it is possible to achieve a balance between the firm binding force between the solid particles and the suppression of the increase in interfacial resistance.

The inorganic solid electrolyte-containing composition according to the embodiment of the present invention is preferably used a material (a constitutional layer forming material) for forming a solid electrolyte layer or an active material layer, where the material is for a sheet for an all-solid state secondary battery, an electrode sheet for an all-solid state secondary battery, or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and lower resistance and high cycle characteristics can be achieved in this aspect while a high active material capacity is provided.

The inorganic solid electrolyte-containing composition according to the embodiment of the present invention is preferably a non-aqueous composition. In the present invention, the non-aqueous composition includes not only an aspect including no moisture but also an aspect where the moisture content (also referred to as the “water content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value determined by filtration through a 0.02 μm membrane filter and then by the Karl Fischer titration.

The inorganic solid electrolyte-containing composition according to the embodiment of the present invention includes an aspect including not only an inorganic solid electrolyte but also an active material, as well as a conductive auxiliary agent or the like (the composition in this aspect may be referred to as the “composition for an electrode”).

Hereinafter, constitutional components that are contained and constitutional components that can be contained in the inorganic solid electrolyte-containing composition according to the embodiment of the present invention will be described.

### Inorganic Solid Electrolyte

The inorganic solid electrolyte-containing composition according to the embodiment of the present invention contains an inorganic solid electrolyte.

In the present invention, the inorganic solid electrolyte is an inorganic solid electrolyte, and the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since the inorganic solid electrolyte does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has an ion lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based solid electrolyte. The sulfide-based inorganic solid electrolytes are preferably used from the viewpoint that it is possible to form a more favorable interface between the active material and the inorganic solid electrolyte.

### (i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{C1}S_{d1}Aₑ₁ Formula (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F, and al to el represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase an ion lithium ion conductivity. Specifically, the ion conductivity of the lithium ion can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—Ges₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature become possible, and it is possible to simplify manufacturing processes.

### (ii) Oxide-Based Inorganic Solid Electrolytes

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number between 0 and 0.1, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen atom; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

### (iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured in the following procedure. The inorganic solid electrolyte particles are diluted and prepared using water (butyl butyrate in a case where the inorganic solid electrolyte is unstable in water) in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle diameter distribution measurement instrument LA-920 (product name, manufactured by Horiba Ltd.), and a quartz cell for measurement at a temperature of 25° C. to obtain the volume average particle diameter. Other detailed conditions and the like can be found in JIS Z 8828: 2013 “particle diameter Analysis-Dynamic Light Scattering” as necessary. Five samples per level are produced and measured, and the average values thereof are employed.

One kind of inorganic solid electrolyte may be contained, or two or more kinds thereof may be contained.

In a case of forming a solid electrolyte layer, the mass (mg) (mass per unit area) of the inorganic solid electrolyte per unit area (cm²) of the solid electrolyte layer is not particularly limited. It can be appropriately determined according to the designed battery capacity and can be set to, for example, 1 to 100 mg/cm².

However, in a case where the inorganic solid electrolyte-containing composition contains an active material described later, the mass per unit area of the inorganic solid electrolyte is preferably such that the total amount of the active material and the inorganic solid electrolyte is in the above range.

The content of the inorganic solid electrolyte in the inorganic solid electrolyte-containing composition is not particularly limited. However, in terms of the reduction of interfacial resistance and the binding property, it is preferably 50% by mass or more, more preferably 70% by mass or more, and still more preferably 90% by mass or more, with respect to 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described below, regarding the content of the inorganic solid electrolyte in the inorganic solid electrolyte-containing composition, the total content of the active material and the inorganic solid electrolyte is preferably in the above-described range.

In the present specification, the solid content (solid constitutional component) refers to constitutional components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a constitutional component other than a dispersion medium described below.

### Polymer Binder

It sufficed that the inorganic solid electrolyte-containing composition according to the embodiment of the present invention contains at least the particulate polymer binder A and the polymer binder B consisting of a polymer having a crystallization temperature of 60° C. or higher, and it may contain another polymer binder. In the present invention, each of the binder polymer binder A, the polymer binder B, and the other binder may be one kind or a plurality of kinds.

It suffices that the number of kinds of polymer binders contained in the inorganic solid electrolyte-containing composition according to the embodiment of the present invention may be 2 or more. In general, 2 to 4 kinds are preferable, and two of one kind of the polymer binder A and one kind of the polymer binder B are more preferable.

### Polymer Binder A

The polymer binder A is contained in the shape of particles in the inorganic solid electrolyte-containing composition, and it is preferably present in the shape of solid (maintaining the particulate shape) even in the constitutional layers described later.

In a case where the particulate polymer binder A is used in combination with the polymer binder B in the inorganic solid electrolyte-containing composition, the interfacial resistance between the solid particles can be reduced without impairing the firm binding between the solid particles.

The fact that “particulate in the inorganic solid electrolyte-containing composition” means that the binder is present (preferably dispersed as insoluble particles (in a solid state without being dissolved in the dispersion medium) in the dispersion medium which is preferably contained in the inorganic solid electrolyte-containing composition. In the present invention, the polymer binder that is present in a solid state in the inorganic solid electrolyte-containing composition (the dispersion medium) is referred to as a particulate polymer binder.

In the present invention, “insoluble in the organic solvent” means that the solubility in the non-polar dispersion medium calculated according to the method described in Examples is 1% by mass or less. On the other hand, “soluble in the dispersion medium” means that the solubility in the non-polar dispersion medium calculated according to the method described in Examples is more than 1% by mass and preferably 2% by mass or more.

In a case where the polymer binder is a particulate polymer binder, the shape thereof is not particularly limited and may be a flat shape, an amorphous shape, or the like; however, a spherical shape or a granular shape is preferable. The average particle diameter of the particulate polymer binders is not particularly limited; however, it is preferably 5,000 nm or less, more preferably 1,500 nm or less, and still more preferably 1,000 nm or less. The lower limit thereof is 1 nm or more, and it is preferably 5 nm or more, more preferably 10 nm or more, and still more preferably 100 nm or more. The average particle diameter of the particulate polymer binder can be measured using the same method as that of the average particle diameter of the inorganic solid electrolyte.

The particle diameter of the particulate polymer binder in the constitutional layer of the all-solid state secondary battery is measured, for example, by disassembling the battery to peel off the constitutional layer containing the particulate polymer binder, subsequently subjecting the constitutional layer to measurement, and excluding the measured value of the particle diameter of particles other than the particulate polymer binder, which has been measured in advance.

The particle diameter of the particulate polymer binder can be adjusted, for example, with the kind of the dispersion medium and the content of the constitutional component in the polymer.

The polymer binder A preferably has a high adsorption rate with respect to the inorganic solid electrolyte in that it can reinforce the binding force of the polymer binder B and realize firm binding between solid particles. For example, the adsorption rate of the polymer binder A with respect to the inorganic solid electrolyte is not particularly limited; however, it is 15% or more, preferably 25% or more, more preferably 50% or more, and still more preferably 55% or more in that firm binding between solid particles can be realized. On the other hand, the upper limit of the adsorption rate is not particularly limited; however, it is practically 99.9%, and it is preferably 90% or less in terms of dispersibility.

In the present invention, the adsorption rate of a polymer binder is an indicator that indicates an extent to which, in the dispersion medium, a polymer binder adsorbs to the inorganic solid electrolyte contained in the inorganic solid electrolyte-containing composition in which the polymer binder is used. Here, the adsorption of the polymer binder to the inorganic solid electrolyte includes not only physical adsorption but also chemical adsorption (adsorption by chemical bond formation, adsorption by transfer of electrons, or the like). In addition, butyl butyrate is generally used as a dispersion medium, which may be different from the dispersion medium contained in the inorganic solid electrolyte-containing composition in which the polymer binder is used. As a result, in a case where the inorganic solid electrolyte-containing composition contains a plurality of kinds of inorganic solid electrolytes, the adsorption rate is an adsorption rate with respect to the inorganic solid electrolyte having the same composition (kind and content) as the composition of the inorganic solid electrolyte in the inorganic solid electrolyte-containing composition. Similarly, also in a case where a plurality of kinds of polymer binders are used, the adsorption rate is an adsorption rate in the case where the plurality of kinds of polymer binders are used.

In the present invention, the adsorption rate of the polymer binder is a value calculated by the method described in Examples.

In the present invention, the adsorption rate with respect to the inorganic solid electrolyte is appropriately set depending on the kind (the structure and the composition of the polymer chain) of polymer that forms the polymer binder, the kind or content of the functional group contained in the polymer, the morphology of the polymer binder (the particulate polymer binder or the soluble type polymer binder), the presence or absence of the crystalline component and the content of the crystalline component, and the like.

In a case where the inorganic solid electrolyte-containing composition according to the embodiment of the present invention contains an active material described later (in a case where an active material layer is formed of the inorganic solid electrolyte-containing composition), the adsorption rate of the polymer binder A with respect to the active material is not particularly limited; however, it is preferably 10% or more, more preferably 20% to 99.9%, and still more preferably 30% to 99%, in terms of further improvement of the binding property. In the present invention, the adsorption rate of a binder to an active material is an indicator that indicates the extent to which, in a dispersion medium, a binder adsorbs to the active material contained in the inorganic solid electrolyte-containing composition in which the binder is used. Here, the adsorption of the polymer binder to the active material includes not only physical adsorption but also chemical adsorption (adsorption by chemical bond formation, adsorption by transfer of electrons, or the like). In addition, butyl butyrate is generally used as a dispersion medium, which may be different from the dispersion medium contained in the inorganic solid electrolyte-containing composition in which the polymer binder is used. As a result, in a case where the inorganic solid electrolyte-containing composition contains a plurality of kinds of active materials, the adsorption rate is the same as that of the polymer binder with respect to the inorganic solid electrolyte, described above, in a case where a plurality of kinds of polymer binders are used. In the present invention, the adsorption rate of the polymer binder with respect to the active material is a value calculated by the method described in Examples. In the present invention, the adsorption rate with respect to the active material can be appropriately set in the same manner as the adsorption rate with respect to the inorganic solid electrolyte.

The polymer that forms the polymer binder A may be a crystalline polymer or may be a non-crystalline polymer, and it is preferably a non-crystalline polymer in that it has a high adsorption rate and exhibits a firm binding property. In the present invention, although the details will be described later, the crystalline polymer means a polymer having a crystallization temperature, and the non-crystalline polymer means a polymer that does not have a crystallization temperature (a crystallization peak is not observed in the thermal analysis described later). The control of the crystalline polymer and the non-crystalline polymer will also be described later.

In the present invention, it is preferable that the polymer that forms the polymer binder A that is used in combination with the polymer binder B does not melt or undergo glass transition at a temperature lower than the crystallization temperature of the polymer that forms the polymer binder B. This makes it is possible to maintain a predetermined particulate shape even in the constitutional layer and effectively reinforce the enhancement of the binding property and the reduction of the interfacial resistance by the polymer binder B.

The SP value of the polymer that forms the polymer binder A is not particularly limited; however, it is preferably 10 to 23, more preferably 10 to 22, and still more preferably 11 to 21, in terms of compatibility of the inorganic solid electrolyte-containing composition and improvement of dispersibility in a case where a dispersion medium is contained. The SP value of the polymer can be adjusted depending on the kind or the composition (the kind and the content of the constitutional component) of the polymer. The method of measuring the SP value will be described later.

The peel strength of the polymer binder A with respect to the collector is not particularly limited and is appropriately set. For example, it can be set in the same range as that of the peel strength of the polymer binder B, described later, with respect to the collector. This makes it possible to enhance the adhesiveness between the collector and the active material layer in a case of forming the active material layer with the inorganic solid electrolyte-containing composition according to the embodiment of the present invention.

The content of the polymer binder A in the inorganic solid electrolyte-containing composition is not particularly limited. However, in terms of the enhancement of the binding property and the reduction of the interfacial resistance, it is preferably 0.1% to 5.0% by mass, more preferably 0.2% to 3.0% by mass, and still more preferably 0.3% to 1.0% by mass, with respect to 100% by mass of the solid content. The content of the polymer binder A is appropriately set within the above range. However, the lower limit thereof is preferably a content in which the polymer binder A is not dissolved in the inorganic solid electrolyte-containing composition (the particulate state can be maintained) in consideration of the solubility of the polymer binder A.

In the inorganic solid electrolyte-containing composition, the content of the polymer binder A may be lower than the content of the polymer binder B described later; however, it is preferably equal to or higher than the content of the polymer binder B. This makes it possible to improve the enhancement of the binding property and the reduction of the interfacial resistance. The difference in content between the polymer binder A and the polymer binder B (the content of the polymer binder A−the content of the polymer binder B) is not particularly limited, it can be, for example, −5.0% to 5.0% by mass, and it is preferably 0.0% by mass or more, more preferably 0.0% to 4.0% by mass, and can be 0.2 to 2.0% by mass. In addition, the ratio of the content of the polymer binder A to the content of the polymer binder B (the content of the polymer binder A/the content of the polymer binder B) is not particularly limited; however, it is, for example, preferably 0.5 to 30 and more preferably 1 to 10.

### Polymer Binder B

The polymer binder B consists of a polymer having a crystallization temperature of 60° C. or higher. In the present invention, the description that the polymer binder is constituted of a polymer means that a polymer is contained to constitute the polymer binder, and in addition to the aspect formed only of a polymer, an aspect formed of a mixture containing a polymer or the like is included. As a result, the polymer binder B also has a crystallization temperature of 60° C. or higher.

The crystalline polymer that forms the polymer binder B generally has a crystalline component and a non-crystalline component. In the present invention, the crystalline component means a constitutional component having a crystallization temperature in the thermal analysis described later, and the non-crystalline component means a constitutional component that does not have a crystallization temperature.

The method of imparting crystallinity to a polymer that forms the polymer binder B is ambiguous according to the kind of polymer.

For a chain polymerization type polymer, examples thereof include setting of the primary structure of a polymer and controlling of the secondary structure of a polymer. Specifically, in a case where the regularity of the primary structure of a polymer is increased, crystallinity is not exhibited, and crystallinity can be exhibited by, for example, the control of the polymerization mode of a block polymer, alternate polymer, or the like, and tacticity (stereoregularity) such as tacticity and syndiotacticity), and by the expression of the folded structure.

For a sequential polymerization type polymer, examples thereof include setting the primary structure of a polymer and controlling the secondary structure of a polymer. Specifically, crystallinity can be exhibited by selecting a functional group or the like.

In the present invention, the degree of adjustment in each method of imparting crystallization is not particularly limited as long as the crystallization temperature can be confirmed to be 60° C. or higher, and the method appropriately determined. In a case of a block polymer, examples of the adjustment item include the degree of polymerization or mass ratio of each block, and the kind and content of the constitutional component that constitutes each block, where these are appropriately determined according to the crystallization temperature.

Whether or not a polymer has crystallinity can be checked by the presence of a crystallization peak in the following method of measuring a crystallization temperature.

The crystallization temperature of the crystalline polymer is 60° C. or higher. In a case where the polymer binder B is formed of a polymer having a crystallization temperature of 60° C. or higher, the crystalline component easily interacts with solid particles, and the solid particles can be bound to each other without impairing the interfacial contact state between the solid particles. In particular, in a case of being melted in the drying step, the crystalline component becomes in a crystalline state at room temperature after the melting, and thus the solid particles can be firmly bound while ensuring the interfacial contact state between the solid particles. The crystallization temperature is preferably 70° C. or higher, more preferably 75° C. or higher, and still more preferably 80° C. or higher, in that both reductions of interfacial resistance and enhancement of binding property can be achieved in a well-balanced manner at a high level. On the other hand, the upper limit of the crystallization temperature is not particularly limited; however, it is practically 150° C. or lower, preferably 140° C. or lower, more preferably 135° C. or lower, and still more preferably 130° C. or lower, in terms of promoting melting during drying.

The crystallization temperature of the polymer can be measured by thermal analysis. Specifically, the glass transition temperature (Tg) is measured using a dry sample of the polymer as a measurement target with a differential scanning calorimeter “X-DSC7000” (trade name, manufactured by SII NanoTechnology Inc.) under the following conditions. The measurement is carried out twice for the same sample, and the result of the second measurement is employed.

Atmosphere in measuring chamber: nitrogen gas (50 mL/min)

Temperature rising rate: 5° C./min

Measurement start temperature: −50° C.

Measurement end temperature: 350° C.

Sample pan: aluminum pan

Mass of measurement sample: 5 mg

Calculation of crystallization temperature: The crystallization temperature is calculated by rounding off the decimal point of the endothermic peak temperature of the DSC chart.

In a case where an all-solid state secondary battery is used, the glass transition temperature can be obtained, for example, by disassembling the all-solid state secondary battery to peel off an active material layer or a solid electrolyte layer, putting the active material layer or the solid electrolyte layer into water to disperse a material thereof, filtering the dispersion liquid, collecting the remaining solid, and measuring the crystallization temperature of the solid using the above-described measurement method.

A polymer is used as a measurement target for the crystallization temperature. However, in general, the same measured value can be obtained even in a case where a polymer binder is used as a measurement target, and thus the crystallization temperature of the polymer binder can be used instead. The polymer binder B in the constitutional layer can be recovered from the constitutional layer and measured.

The crystallization temperature of the polymer can be appropriately set depending on the degree of adjustment in the method of imparting crystallinity, the kind of polymer (the polymer composition), the kind or content of the functional group of the polymer, the molecular weight, and the like.

In the polymer that forms the polymer binder B, the content proportions of the crystalline component and the non-crystalline component are not particularly limited as long as the above crystallization temperature is satisfied, and they can be appropriately set according to the kind of polymer, the level of the crystallization temperature, and the like. For example, the content proportion of the crystalline component is preferably 30% to 90% by mass and more preferably 40% to 80% by mass in 100% by mass of the polymer.

In the inorganic solid electrolyte-containing composition, the polymer binder B may be a particulate polymer binder or may be present in a state of being dissolved in a dispersion medium (the polymer binder present in a state of being dissolved is referred to as a soluble type polymer binder). In the present invention, a soluble type polymer binder is preferable in terms of the balance between the enhancement of the binding property between the solid particles and the reduction of the interfacial resistance. In particular, in a case where a soluble type polymer binder is used as the polymer binder B and the drying temperature of the constitutional layer is set to equal to or higher than the crystallization temperature, the crystalline component of the polymer binder can be once melted and then recrystallized, which is preferable in that the more firm binding is possible while sufficiently ensuring the interfacial contact between the solid particles.

In the case of a soluble type polymer binder, the solubility in a non-polar dispersion medium (generally butyl butyrate) is not particularly limited as long as it is 2% by mass or more; however, it is preferably 3% by mass or more and preferably 5% by mass or more. On the other hand, the upper limit of the solubility thereof is not particularly limited, and it can be, for example, 70% by mass, and it is preferably 60% by mass or less.

The solubility of the polymer binder B can be appropriately set depending on the kind of polymer (the structure and composition of the polymer chain), the kind or content of functional group of the polymer, the presence or absence and content of crystalline component, the molecular weight, and the like.

In a case where the polymer binder B is a particulate polymer binder, the solubility and the average particle diameter can be set to be the same as those of the above-described polymer binder A.

The adsorption rate of the polymer binder B with respect to the inorganic solid electrolyte is not particularly limited; however, it is less than 10%, and it is preferably less than 8%, more preferably less than 5%, still more preferably 4% or less, and particularly preferably 0% or more and 3% or less. In a case where the polymer binder B exhibits the above adsorption rate, it is possible to prevent the aggregation of the inorganic solid electrolyte particles, obtain a sheet in which the particles are uniformly dispersed during coating and drying, and realize good battery resistance and cycle characteristics.

In a case where the inorganic solid electrolyte-containing composition according to the embodiment of the present invention contains an active material described later, the adsorption rate of the polymer binder B with respect to the active material is not particularly limited; however, it is preferably 0% to 99.9%, more preferably 2% to 50%, and still more preferably 3# to 25%, in terms of binding property.

The adsorption rate of the polymer binder, and the measurement method as well as the control method thereof are as described in the polymer binder A.

The SP value of the polymer that forms the polymer binder B is not particularly limited; however, it is preferably 10 to 23, more preferably 10 to 20, and still more preferably 11 to 19, in terms of compatibility of the inorganic solid electrolyte-containing composition and improvement of dispersibility in a case where a dispersion medium is contained. The SP value of the polymer can be adjusted depending on the kind or the composition (the kind and the content of the constitutional component) of the polymer.

The SP value of the polymer is measured as follows.

In the present invention, the SP value is determined according to the Hoy method unless otherwise specified (see H. L. Hoy JOURNAL OF PAINT TECHNOLOGY, Vol. 42, No. 541, 1970, 76-118, and POLYMER HANDBOOK 4^{th}, Chapter 59, VII, page 686, Table 5, Table 6, and the following formula in Table 6).

It is noted that the SP value is shown with the unit being omitted; however, the unit thereof is MPa^{1/2}.

$${δ}_{r} = \frac{{F}_{t} + \frac{B}{\overline{n}}}{V} ; B = 227$$

In the expression, δₜ indicates an SP value. Ft is a molar attraction function (J×cm³)^{1/2}/mol and represented by the following expression. V is a molar volume (cm³/mol) and represented by the following expression. n̅ is represented by the following expression.

$${F}_{t} = \sum {n}_{i} {F}_{t , i}$$

$$V = \sum {n}_{i} {V}_{i}$$

$$\overline{n} = \frac{0.5}{{Δ}_{T}^{( P )}}$$

$${Δ}_{T}^{( P )} = \sum {n}_{i} {Δ}_{T , i}^{( P )}$$

In the above formula, F_{t,i} indicates a molar attraction function of each constitutional unit, Vᵢ indicates a molar volume of each constitutional unit. Δ^{(P)}_{T,i} indicates a correction value of each constitutional unit, and nᵢ indicates the number of each constitutional unit.

The SP value of the polymer is calculated according to the following expression using the constitutional component (derived from the raw material compound) and the SP value thereof. It is noted that the SP value of the constitutional component obtained according to the above document is converted into an SP value (MPa^{1/2}) (for example, 1 cal^{1/2} cm^{-3/2}≈2.05 J^{1/2} cm^{-3/2}≈2.05 MPa^{1/2}) and used.

$$S {P}_{P}^{2} = ( {SP}_{1}^{2} \times {W}_{1} ) + ( {SP}_{2}^{2} \times {W}_{2} ) + …$$

In the expression, SP₁, SP₂ . . . indicates the SP values of the constitutional components, and W₁, W₂ . . . indicates the mass fractions of the constitutional components. In the present invention, the mass fraction of a constitutional component shall be a mass fraction of the constitutional component (the raw material compound from which this constitutional component is derived) in the polymer.

The peel strength of the polymer binder B with respect to the collector is not particularly limited and is appropriately set. In a case of forming the active material layer with the inorganic solid electrolyte-containing composition according to the embodiment of the present invention, it is preferably 0.1 N/mm or more, more preferably 0.2 N/mm or more, and still more preferably 0.3 N/mm or more, in that the adhesiveness between the collector and the active material layer can be enhanced. The upper limit thereof is not particularly limited; however, it is, for example, practically 10 N/mm or less, and it is preferably 2.0 N/mm or less. The collector to which the above peel strength is applied is not particularly limited as long as it is the one described later; however, examples thereof include copper foil, aluminum foil, and stainless steel (SUS) foil. The peel strength is a value calculated by the same method as the method (the method for peel strength with respect to the aluminum foil or copper foil) described in Examples regardless of the kind of collector. In the present invention, the peel strength can be appropriately set in the same manner as the adsorption rate with respect to the inorganic solid electrolyte.

The content of the polymer binder B in the inorganic solid electrolyte-containing composition is not particularly limited. However, in terms of the enhancement of the binding property and the reduction of the interfacial resistance, it is preferably 0.01% to 5% by mass, more preferably 0.05% to 2.0% by mass, and still more preferably 0.1% to 1.0% by mass, with respect to 100% by mass of the solid content.

The content of the polymer binder A in the inorganic solid electrolyte-containing composition is not particularly limited. However, in terms of the enhancement of the binding property and the reduction of the interfacial resistance, it is preferably more than 0.5% and 3.0% by mass or less, more preferably 0.6% to 2.5% by mass, and still more preferably 0.7% to 2.0% by mass, with respect to 100% by mass of the solid content.

In the present invention, the mass ratio [(the mass of the inorganic solid electrolyte+the mass of the active material)/(the total mass of the polymer binder)] of the total mass (the mass of the polymer binder A+the mass of the polymer binder B) of the inorganic solid electrolyte and the active material to the total mass of the polymer binder A and the polymer binder B is preferably in a range of 1,000 to 1. Furthermore, this ratio is more preferably 500 to 2 and still more preferably 100 to 10.

### Polymer that Forms Polymer Binder

The polymers that form the polymer binders A and B are not particularly limited as long as they are polymers capable of forming a particulate polymer binder or a polymer having a crystallization temperature of 60° C. or higher, and can be appropriately selected, for example, from various polymers generally used in the constitutional layer of the all-solid state secondary battery. Examples of the polymer that forms each polymer binder include sequential polymerization (a polycondensation, a polyaddition, or an addition condensation) type polymers such as polyurethane, polyurea, polyamide, polyimide, polyester, polyether, and polycarbonate, and further include chain polymerization type polymers such as a fluorine-based polymer, a hydrocarbon-based polymer, a vinyl polymer, and (meth)acrylic polymer.

Examples of each of polyurethane, polyurea, polyamide, and polyimide polymers, which can be adopted as a sequential polymerization type polymer, include a polymer (a polymeric binder (B)) having a hard segment and a soft segment described in JP2015-088480A, a polymer that forms a binder having at least one constitutional component represented by a specific formula, described in WO2018/147051A, and each of the polymers described in WO2018/020827A and WO2015/046313A.

Examples of the fluorine-based polymer, which are not particularly limited, include polytetrafluoroethylene (PTFE), polyvinylene difluoride (PVdF), a copolymer of polyvinylene difluoride and hexafluoropropylene (PVdF-HFP), and a copolymer (PVdF-HFP-TFE) of polyvinylidene difluoride, hexafluoropropylene, and tetrafluoroethylene. In PVdF-HFP, the copolymerization ratio [PVdF:HFP] (mass ratio) of PVdF to HFP is not particularly limited; however, it is preferably 9:1 to 5:5 and more preferably 9:1 to 7:3 in terms of dispersion stability. In PVdF-HFP-TFE, the copolymerization ratio [PVdF:HFP:TFE] (mass ratio) of PVdF, HFP, and TFE is not particularly limited; however, it is preferably 20 to 60:10 to 40:5 to 30.

Examples of the hydrocarbon-based polymer, which are not particularly limited, include polyethylene, polypropylene, a polyethylene-poly(ethylene-butyl)-polyethylene copolymer, natural rubber, polybutadiene, polyisoprene, polystyrene, a polystyrene butadiene copolymer, a polypropylene-polyethylene-polybutylene copolymer (CEBC), a styrene-based thermoplastic elastomer, polybutylene, an acrylonitrile-butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), and a hydrogenated a styrene-butadiene rubber (HSBR). In the present invention, the hydrocarbon-based polymer preferably does not have an unsaturated group (for example, a 1,2-butadiene constitutional component) that is bonded to the main chain from the viewpoint that the formation of chemical crosslink can be suppressed.

Examples of the vinyl polymer include a polymer containing a vinyl monomer other than the (meth)acrylic compound (M1), where the content of the vinyl polymer is, for example, 50% by mole or more. Examples of the vinyl monomer include vinyl compounds described later. Specific examples of the vinyl polymer include polyvinyl alcohol, polyvinyl acetal, polyvinyl acetate, and a copolymer containing these.

In addition to the constitutional component derived from the vinyl monomer, this vinyl polymer preferably has a constitutional component derived from the (meth)acrylic compound (M1) that forms a (meth)acrylic polymer described later and further, a constitutional component (MM) derived from a macromonomer described later. The content of the constitutional component derived from the vinyl monomer is preferably the same as the content of the constitutional component derived from the (meth)acrylic compound (M1) in the (meth)acrylic polymer. The content of the constitutional component derived from the (meth)acrylic compound (M1) in the polymer is not particularly limited as long as it is less than 50% by mole; however, it is preferably 0% to 40% by mole and preferably 5% to 35% by mole. The content of the constitutional component (MM) in the polymer is preferably the same as the content in the (meth)acrylic polymer.

The (meth)acrylic polymer is preferably a polymer obtained by (co)polymerizing at least one (meta)acrylic compound (M1) selected from a (meth)acrylic acid compound, a (meth)acrylic acid ester compound, a (meth)acrylamide compound, or a (meth)acrylonitrile compound. Further, a (meth)acrylic polymer consisting of a copolymer of the (meth)acrylic compound (M1) and another polymerizable compound (M2) is also preferable. The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, and a dialkyl itaconate compound. Examples of the vinyl compound include the “vinyl monomer” disclosed in JP2015-88486A.

The content of the other polymerizable compound (M2) in the (meth)acrylic polymer is not particularly limited; however, it can be, for example, less than 50% by mole.

Examples of the (meth)acrylic polymer include a polymer described in WO2016/132872A, in which a macromonomer having a mass average molecular weight of 1,000 or more is incorporated as a side chain component and which has at least one of the following group of functional groups (b).

In addition, examples the polymer binder consisting of a (meth)acrylic polymer include a binder particle (B) disclosed in JP2015-88486A, which has an average particle diameter of 10 nm or more 1,000 nm or more and into which a macromonomer (X) having a number average molecular weight of 1,000 or more is incorporated as a side chain component, particularly a binder consisting of a polymer into which a macromonomer containing a self-condensate of 12-hydroxystearic acid is incorporated.

Among the above-described polymers, examples of the polymer having a crystallization temperature of 60° C. or higher include a hydrocarbon-based polymer, a fluorine-based polymer, polyamide, and polyphenylene sulfide.

Examples of the hydrocarbon-based polymer include a block copolymer of polyethylene-block poly(ethylene-butylene)-block polyethylene, a block copolymer of propylene-ethylene-butylene (CEBC).

In addition, examples of the fluorine-based polymer include a polyvinylidene fluoride-hexafluoropropylene copolymer (PVDF-HFP), a polyvinylidene fluoride-hexafluoropropylene-tetrafluoroethylene copolymer (PVDF-HFP-TFE), polytetrafluoroethylene (PTFE), and a block copolymer thereof.

In the present invention, the polymer that forms the polymer binder A is preferably polyurethane, a (meth)acrylic polymer, or a fluorine-based polymer, and more preferably polyurethane or a (meth)acrylic polymer. The polymer that forms the polymer binder B is preferably a fluorine-based polymer, a hydrocarbon-based polymer, a polyurethane, or a (meth)acrylic polymer, and more preferably a fluorine-based polymer or a hydrocarbon-based polymer.

### -Functional Group

The polymer that forms a binder preferably has a functional group for increasing the wettability or adsorptivity to the surface of the solid particle such as the inorganic solid electrolyte. Examples of such a functional group include a group that exhibits a physical interaction, such as a hydrogen bond, on the surface of the solid particle and a group that can form a chemical bond with a group present on the surface of the solid particle, and the functional group more preferably has at least one group selected from the following group (I) of functional groups. However, from the viewpoint of more effectively exhibiting the wettability or adsorptivity of the solid particle to the surface, it is preferable not to include two or more groups capable of forming a bond between the functional groups.

### Group (I) of Functional Groups

An acidic group, a group having a basic nitrogen atom, an amide group, a urea group, a urethane group, an alkoxysilyl group, an epoxy group, an isocyanate group, a hydroxy group, and a (meth)acryloyloxy group

The acidic group is not particularly limited. Examples thereof include a carboxylate group (—COOH), a sulfonate group (sulfo group: —SO₃H), a phosphate group (phospho group: —OPO(OH)₂), a phosphonate group, and a phosphinate group, where a carboxylate group is preferable.

Examples of the group having a basic nitrogen atom include an amino group, a pyridyl group, an imino group, and an amidine group (—C(═NR)—NR₂). The amino group is synonymous with the amino group of the substituent Z described later; however, an unsubstituted amino group or an alkylamino group is preferable. Each of the three R's of the amidine group represents a hydrogen atom or a substituent (for example, a group selected from the substituent Z described later).

Preferred examples of the urea group include —NR¹⁵(CONR¹⁶R¹⁷ (here, R¹⁵, R¹⁶, and R¹⁷ represent a hydrogen atom, an alkyl group having 1 to 20 carbon atoms, an aryl group having 6 or more carbon atoms, or an aralkyl group having 7 or more carbon atoms). The urea group is preferably —NR¹⁵CONHR¹⁷ (here, R¹⁵ and R¹⁷ represent a hydrogen atom, an alkyl group having 1 to 10 carbon atoms, an aryl group having 6 or more carbon atoms, or an aralkyl group having 7 or more carbon atoms) is more preferable, and particularly preferably —NHCONHR¹⁷ (here, R¹⁷ represents a hydrogen atom, an alkyl group having 1 to 10 carbon atoms, an aryl group having 6 or more carbon atoms, or an aralkyl group having 7 or more carbon atoms).

Preferred examples of the urethane group include a group including at least an imino group and a carbonyl group such as —NHCOOR¹⁸, —NR¹⁹COOR²⁰, —OCONHR²¹, or —OCONR²²R²³ (here, R¹⁸, R¹⁹, R²⁰, R²¹, R²², and R²³ represent an alkyl group having 1 to 20 carbon atoms, an aryl group having 6 or more carbon atoms, or an aralkyl group having 7 or more carbon atoms). The urethane group is preferably —NHCOOR¹⁸ or —OCONHR²¹ (here, R¹⁸ and R²¹ represent an alkyl group having 1 to 20 carbon atoms, an aryl group having 6 or more carbon atoms, or an aralkyl group having 7 or more carbon atoms), and particularly preferably —NHCOOR¹⁸, —OCONHR²¹ (here, R¹⁸ and R²¹ represent an alkyl group having 1 to 10 carbon atoms, an aryl group having 6 or more carbon atoms, or an aralkyl group having 7 or more carbon atoms).

The amide group is not particularly limited; however, preferred examples thereof include groups containing a carbonyl group and an amino group or imino group, such as —CONR¹⁶R¹⁷ and —NR¹⁵—COR¹⁸ (R¹⁵ to R¹⁸ are as described above). The amide group is preferably —NR¹⁵—COR¹⁸ and more preferably —NHCOR¹⁸.

The alkoxysilyl group is not particularly limited, and examples thereof include a mono-, di-, or, tri-alkoxysilyl group. It includes an alkoxysilyl group preferably having 1 to 20 carbon atoms and more preferably 1 to 6 carbon atoms. Examples thereof include a methoxysilyl group, an ethoxysilyl group, a t-butoxysilyl group, and a cyclohexylsilyl group, as well as each group exemplified by the substituent Z described later.

Examples of the (meth)acryloyloxy group include an acryloyloxy group and a methacryloyloxy group.

The acidic group, the group having a basic nitrogen atom, the hydroxyl group, and the like may form a salt.

The functional group contained in the polymer that forms the polymer binder is preferably an acidic group, an alkoxysilyl group, an amide group, a urea group, a urethane group, or an epoxy group, and more preferably an acidic group.

The polymer that forms a polymer binder may have a functional group selected from the group (I) of functional groups in any one of the constitutional components that form a polymer and in any one of the main chain or the side chain of the polymer.

The method of incorporating a functional group into a polymer chain is not particularly limited, and examples thereof include a method of using a polymerizable compound having a functional group selected from the Group (I) of functional groups as a copolymerizable polymerizable compound, a method of using a polymerization initiator having (generating) the above-described functional group or a chain transfer agent, and a method of using a polymeric reaction.

The content of the functional group selected from the group (I) of functional groups, in the polymer that forms the polymer binder A, is not particularly limited. However, in all the constitutional components that constitute a polymer that forms a polymer binder, the proportion of the constitutional component having a functional group selected from the group (I) of functional groups is preferably 0.01% to 50% by mole, more preferably 0.02% to 49% by mole, still more preferably 0.1% to 40% by mole, even still more preferably 1% to 30% by mole, and particularly preferably 3% to 25% by mole.

On the other hand, the content of the functional group selected from the group (I) of functional groups, in the polymer that forms the polymer binder B, is not particularly limited. However, in all the constitutional components that constitute a polymer that forms a polymer binder, the proportion of the constitutional component having a functional group selected from the group (I) of functional groups is preferably 20% by mole or less, more preferably 5% by mole or less, still more preferably 1% by mole or less, and even still more preferably 0.7% by mole or less.

The polymer (each constitutional component and raw material compound) that forms a polymer binder may have a substituent. The substituent is not particularly limited; however, examples thereof preferably include a group selected from the following substituent Z.

### Substituent Z

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein when being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group; in the present specification, the aryloxy group has a meaning including an aryloyloxy group therein when being referred to); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, an arylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, a benzoyloxy group, a naphthoyloxy group, or a nicotinoyloxy group); an aryloyloxy group (preferably an aryloyloxy group having 7 to 23 carbon atoms, for example, a benzoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxy group having 6 to 42 carbon atoms, for example, a triphenyloxysilyl group), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

### Physical Properties, Characteristics, or the Like of Polymer Binder or Polymer that Forms Polymer Binder

The polymer that forms a polymer binder may be a non-crosslinked polymer or a crosslinked polymer. Further, in a case where the crosslinking of the polymer proceeds by heating or application of a voltage, the molecular weight may be larger than the above molecular weight. Preferably, the polymer has a mass average molecular weight in the above range at the start of use of the all-solid state secondary battery.

The water concentration of the polymer binder (the polymer) is preferably 100 ppm (mass basis) or less. Further, as this polymer binder, a polymer may be crystallized and dried, or a polymer binder dispersion liquid may be used as it is.

The polymer that forms a polymer binder is preferably noncrystalline. In the present invention, the description that a polymer is “noncrystalline” typically refers to that no endothermic peak due to crystal melting is observed when the measurement is carried out at the glass transition temperature.

The mass average molecular weight of each polymer that forms the polymer binders A and B is not particularly limited and is appropriately determined.

The mass average molecular weight of each polymer that forms the polymer binder A is, for example, preferably 15,000 or more, more preferably 30,000 or more, and still more preferably 50,000 or more. The upper limit thereof is practically 5,000,000 or less, and it is preferably 4,000,000 or less and more preferably 3,000,000 or less.

The mass average molecular weight of the polymer that forms the polymer binder B is, for example, preferably 20,000 or more, more preferably 50,000 or more, still more preferably 200,000 or more. The upper limit thereof is practically 5,000,000 or less, and it is preferably 4,000,000 or less and more preferably 3,000,000 or less.

### Measurement of Molecular Weight

In the present invention, unless specified otherwise, molecular weights of a polymer chain and a macromonomer refer to a mass average molecular weight and number average molecular weight in terms of standard polystyrene equivalent, determined by gel permeation chromatography (GPC). Regarding the measurement method thereof, basically, a value measured using a method under Conditions 1 or Conditions 2 (preferable) described below is employed. However, depending on the kind of polymer or macromonomer, an appropriate eluent may be appropriately selected and used.

### Conditions 1

Column: Connect two TOSOH TSKgel Super AWM-H (trade name, manufactured by Tosoh Co., Ltd.)

Carrier: 10 mM LiBr/N-methylpyrrolidone

Measurement temperature: 40° C.

Carrier flow rate: 1.0 ml/min

Sample concentration: 0.1% by mass

Detector: refractive indicator (RI) detector

### Conditions 2

Column: A column obtained by connecting TOSOH TSKgel Super HZM-H, TOSOH TSKgel Super HZ4000, and TOSOH TSKgel Super HZ2000 (all of which are trade names, manufactured by Tosoh Corporation)

Carrier: tetrahydrofuran

Measurement temperature: 40° C.

Carrier flow rate: 1.0 ml/min

Sample concentration: 0.1% by mass

Detector: refractive indicator (RI) detector

Specific examples of the polymer that forms a polymer binder include those synthesized in Examples; however, the present invention is not limited thereto.

### Dispersion Medium

The inorganic solid electrolyte-containing composition according to the embodiment of the present invention preferably contains a dispersion medium as a dispersion medium that disperses or dissolves each of the above constitutional components, and it more preferably has a slurry form.

It suffices that the dispersion medium is an organic compound that is in a liquid state in the use environment, and specific examples thereof include various solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a solvent having a property of a low affinity to water; however, in the present invention, it is preferably a dispersion medium having a CLogP value of 1.5 to 6, and examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric amide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, and xylene.

Examples of the aliphatic compound include hexane, heptane, octane, decane, cyclohexane, methylcyclohexane, ethylcyclohexane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, butyl acetate, propyl acetate, propyl butyrate, isopropyl butyrate, butyl butyrate, isobutyl butyrate, butyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The compound that constitutes the dispersion medium preferably has a CLogP value of 1 or more, more preferably 1.5 or more, still more preferably 2 or more, and particularly preferably 3 or more. The upper limit thereof is not particularly limited; however, it is practically 10 or less and preferably 6 or less.

In the present invention, the CLogP value is a value obtained by calculating the common logarithm LogP of the partition coefficient P between 1-octanol and water. Known methods and software can be used for calculating the CLogP value. However, unless otherwise specified, a value calculated from a structure that is drawn by using ChemDraw of PerkinElmer, Inc. is used.

In a case where two or more kinds of dispersion media are contained, the ClogP value of the dispersion medium is the sum of the products of the ClogP values and the mass fractions of the respective dispersion media.

Examples of such a dispersion medium among those described above include toluene (CLogP=2.5), xylene (ClogP=3.12), hexane (CLogP=3.9), heptane (Hep, CLogP=4.4), Octane (CLogP=4.9), cyclohexane (CLogP=3.4), cyclooctane (CLogP=4.5), decalin (CLogP=4.8), diisobutyl ketone (DIBK, CLogP=3.0), dibutyl ether (DBE, CLogP=2.57), butyl butyrate (CLogP=2.8), tributylamine (CLogP=4.8), methyl isobutyl ketone (MIBK, ClogP=1.31), and ethylcyclohexane (ECH), ClogP=3.4).

In terms of the dispersibility of the solid particles, the dispersion medium (or a compound that constitutes the dispersion media) preferably has an SP value (MPa^{1/2}) of 9 to 21, more preferably 10 to 20, and still preferably 11 to 19.

The SP value of the dispersion medium is defined as a value obtained by converting the SP value calculated according to the Hoy method described above into the unit of MPa^{1/2}. In a case where the inorganic solid electrolyte-containing composition contains two or more kinds of dispersion media, the SP value of the dispersion medium means the SP value of the entire dispersion media, and it is the sum of the products of the SP values and the mass fractions of the respective dispersion media. Specifically, the calculation is carried out in the same manner as the above-described method of calculating the SP value of the polymer, except that the SP value of each of the dispersion media is used instead of the SP value of the constitutional component.

The dispersion medium preferably has a boiling point of 50° C. or higher, and more preferably 70° C. or higher at normal pressure (1 atm). The upper limit thereof is preferably 250° C. or lower and more preferably 220° C. or lower.

In the inorganic solid electrolyte-containing composition, one kind of the above-described dispersion medium may be contained singly or two or more kinds thereof may be contained.

In the present invention, the content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

### Active Material

The inorganic solid electrolyte-containing composition according to the embodiment of the present invention can also contain an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as a composition for an electrode (a composition for a positive electrode or a composition for a negative electrode).

### Positive Electrode Active Material

The positive electrode active material is preferably a positive electrode active material capable of reversibly intercalating and deintercalating lithium ions. The above-described material is not particularly limited as long as the material has the above-described characteristics and may be a transition metal oxide or an element capable of being complexed with Li such as sulfur or the like.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The amount of the element mixed is preferably 0% to 30% by mole of the amount (100% by mole) of the transition metal element M^{a}. It is more preferable that the transition metal oxide is synthesized by mixing the above constitutional components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particulate shape. The particle diameter (the volume average particle diameter) of the positive electrode active material particles is not particularly limited. For example, it can be set to 0.1 to 50 μm. The particle diameter of the positive electrode active material particle can be measured using the same method as that of the particle diameter of the inorganic solid electrolyte. In order to allow the positive electrode active material to have a predetermined particle diameter, an ordinary pulverizer or classifier is used. For example, a mortar, a ball mill, a sand mill, a vibration ball mill, a satellite ball mill, a planetary ball mill, a swirling air flow jet mill, or a sieve is preferably used. During crushing, it is also possible to carry out wet-type crushing in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

In a case of forming a positive electrode active material layer, the mass (mg) (mass per unit area) of the positive electrode active material per unit area (cm²) of the positive electrode active material layer is not particularly limited. It can be appropriately determined according to the designed battery capacity and can be set to, for example, 1 to 100 mg/cm².

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, with respect to 100% by mass of the solid content.

### Negative Electrode Active Material

The negative electrode active material is preferably capable of reversibly intercalating and deintercalating lithium ions. The material is not particularly limited as long as it has the above-described properties, and examples thereof include a carbonaceous material, a metal oxide, a metal composite oxide, lithium, a lithium alloy, and a negative electrode active material that is capable of forming an alloy with lithium. Among the above, a carbonaceous material, a metal composite oxide, or lithium is preferably used from the viewpoint of reliability.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table). In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with a peak in a range of 20° to 40° in terms of 2θ value in case of being measured by an X-ray diffraction method using CuKα rays, and the oxide may have a crystal diffraction line. The highest intensity in a crystal diffraction line observed in a range of 40° to 70° in terms of 2θ value is preferably 100 times or less and more preferably 5 times or less relative to the intensity of a diffraction peak line in a broad scattering band observed in a range of 20° to 40° in terms of 2θ value, and it is still more preferable that the oxide does not have a crystal diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are more preferable. Specific examples of preferred noncrystalline oxides and chalcogenides include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with noncrystalline oxide negative electrode active material containing Sn, Si, or Ge as a major constitutional component include a carbonaceous material capable of intercalating and/or deintercalating lithium ions or lithium metal, lithium, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy.

The negative electrode active material that is capable of forming an alloy with lithium is not particularly limited as long as it is typically used as a negative electrode active material for a secondary battery. In such an active material, expansion and contraction due to charging and discharging is large, and thus the binding property of the solid particle is reduced. However, in the present invention, it is possible to achieve high binding property by using the above-described polymer binders A and B in combination. Examples of such an active material include a (negative electrode) active material (an alloy) having a silicon element or a tin element and a metal such as Al or In, a negative electrode active material (a silicon-containing active material) having a silicon element capable of that exhibits high battery capacity is preferable, and a silicon-containing active material in which the content of the silicon element is 50% by mole or more with respect to all the constitutional component elements is more preferable.

In general, a negative electrode including the negative electrode active material (for example, a Si negative electrode including a silicon-containing active material or an Sn negative electrode containing an active material containing a tin element) can intercalate a larger amount of Li ions than a carbon negative electrode (for example, graphite or acetylene black). That is, the amount of Li ions intercalated per unit mass increases. Therefore, it is possible to increase the battery capacity. As a result, there is an advantage that the battery driving duration can be extended.

Examples of the silicon-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above baking method can be calculated using an inductively coupled plasma (ICP) emission spectroscopic analysis method as a measurement method from the mass difference of powder before and after firing as a convenient method.

The shape of the negative electrode active material is not particularly limited but is preferably a particulate shape. The volume average particle diameter of the negative electrode active material is not particularly limited; however, it is preferably 0.1 to 60 μm. The volume average particle diameter of the negative electrode active material particles can be measured using the same method as that of the average particle diameter of the inorganic solid electrolyte. In order to obtain the predetermined particle diameter, a typical crusher or classifier is used as in the case of the positive electrode active material.

The negative electrode active material may be used singly, or two or more negative electrode active materials may be used in combination.

In a case of forming a negative electrode active material layer, the mass (mg) (mass per unit area) of the negative electrode active material per unit area (cm²) in the negative electrode active material layer is not particularly limited. It can be appropriately determined according to the designed battery capacity and can be set to, for example, 1 to 100 mg/cm².

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% by mass to 75% by mass with respect to 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. In a case where the ions are bonded to electrons to be precipitated as a metal, a negative electrode active material layer can be formed.

### Coating of Active Material

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, a surface treatment may be carried out on the surfaces of electrodes including the positive electrode active material or the negative electrode active material using sulfur, phosphorous, or the like.

Furthermore, the particle surface of the positive electrode active material or the negative electrode active material may be treated with an active light ray or an active gas (plasma or the like) before or after the coating of the surfaces.

### Conductive Auxiliary Agent

The inorganic solid electrolyte-containing composition according to the embodiment of the present invention may appropriately contain a conductive auxiliary agent, and it is particularly preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, amorphous carbon such as needle cokes, a carbon fiber such as a vapor-grown carbon fiber or a carbon nanotube, or a carbonaceous material such as graphene or fullerene which are electron-conductive materials and also may be a metal powder or a metal fiber of copper, nickel, or the like, and a conductive polymer such as polyaniline, polypyrrole, polythiophene, polyacetylene, or a polyphenylene derivative may also be used.

In the present invention, in a case where the active material and the conductive auxiliary agent are used in combination, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not determined unambiguously but is determined by the combination with the active material.

One kind of conductive auxiliary agent may be contained, or two or more kinds thereof may be contained.

The shape of the conductive auxiliary agent is not particularly limited but is preferably a particulate shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in the solid content of 100% by mass.

### Lithium Salt

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of Li ion secondary2015-088486A are preferable.

In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

### Dispersing Agent

Since the above-described polymer binder functions as a dispersing agent as well, the inorganic solid electrolyte-containing composition according to the embodiment of the present invention may not contain a dispersing agent other than this polymer binder; however, it may contain a dispersing agent. As the dispersing agent, a dispersing agent that is generally used for an all-solid state secondary battery can be appropriately selected and used. Generally, a compound intended for particle adsorption and steric repulsion and/or electrostatic repulsion is suitably used.

### Other Additives

As constitutional components other than the respective constitutional components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. Further, a polymer other than the above polymer, a commonly used binding agent, and the like may be contained.

### Preparation of Inorganic Solid Electrolyte-Containing Composition

The inorganic solid electrolyte-containing composition according to the embodiment of the present invention can be prepared by mixing an inorganic solid electrolyte, the above polymer binder, a dispersion medium, and further appropriately a lithium salt, and any other optionally components, as a mixture and preferably as a slurry by using, for example, various mixers that are used generally.

A mixing method is not particularly limited, and the constitutional components may be mixed at once or sequentially. A mixing environment is not particularly limited, and examples thereof include a dry air environment and an inert gas environment.

The composition for forming an active material layer according to the embodiment of the present invention can be made into a dispersion liquid that contains solid particles that are dispersed at a high level over a long period of time, by suppressing (re)aggregation of the solid particles.

### Sheet for All-Solid State Secondary Battery

A sheet for an all-solid state secondary battery according to the embodiment of the present invention is a sheet-shaped molded body with which a constitutional layer of an all-solid state secondary battery can be formed, and includes various aspects depending on uses thereof. Examples of thereof include a sheet that is preferably used in a solid electrolyte layer (also referred to as a solid electrolyte sheet for an all-solid state secondary battery), and a sheet that is preferably used in an electrode or a laminate of an electrode and a solid electrolyte layer (an electrode sheet for an all-solid state secondary battery). In the present invention, a variety of sheets described above will be collectively referred to as a sheet for an all-solid state secondary battery in some cases.

It suffices that the solid electrolyte sheet for an all-solid state secondary battery according to the embodiment of the present invention is a sheet having a solid electrolyte layer, and may be a sheet in which a solid electrolyte layer is formed on a substrate or may be a sheet that is formed of a solid electrolyte layer without including a substrate. The solid electrolyte sheet for an all-solid state secondary battery may include another layer in addition to the solid electrolyte layer. Examples of the other layer include a protective layer (a stripping sheet), a collector, and a coating layer.

Examples of the solid electrolyte sheet for an all-solid state secondary battery according to the embodiment of the present invention include a sheet including a layer constituted of the inorganic solid electrolyte-containing composition according to the embodiment of the present invention, a typical solid electrolyte layer, and a protective layer on a base material in this order. The solid electrolyte layer included in the solid electrolyte sheet for an all-solid state secondary battery is preferably formed of the inorganic solid electrolyte-containing composition according to the embodiment of the present invention. The contents of the respective constitutional components in the solid electrolyte layer are not particularly limited; however, the contents are preferably the same as the contents of the respective constitutional components with respect to the solid content of the inorganic solid electrolyte-containing composition according to the embodiment of the present invention. The thickness of each layer that constitutes the solid electrolyte sheet for an all-solid state secondary battery is the same as the thickness of each layer described later in the all-solid state secondary battery.

The substrate is not particularly limited as long as it can support the solid electrolyte layer, and examples thereof include a sheet body (plate-shaped body) formed of materials described below regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

It suffices that the electrode sheet for an all-solid state secondary battery according to the embodiment of the present invention (simply also referred to as an “electrode sheet”) is an electrode sheet having an active material layer, and may be a sheet in which an active material layer is formed on a substrate (collector) or may be a sheet that is formed of an active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The contents of the respective constitutional components in this solid electrolyte layer or active material layer are not particularly limited; however, the contents are preferably the same as the contents of the respective constitutional components with respect to the solid content of the inorganic solid electrolyte-containing composition (the composition for an electrode) according to the embodiment of the present invention. The thickness of each of the layers that constitute the electrode sheet according to the embodiment of the present invention is the same as the thickness of each of layers described later in the all-solid state secondary battery. The electrode sheet according to the embodiment of the present invention may include the above-described other layer.

In the sheet for a sheet for an all-solid state secondary battery according to the embodiment of the present invention, at least one layer of the solid electrolyte layer or the active material layer is formed of the inorganic solid electrolyte-containing composition according to the embodiment of the present invention, and the solid particles in this layer are firmly bound to each other while sufficiently ensuring interfacial contact. Further, in the electrode sheet for an all-solid state secondary battery, the active material layer formed of the inorganic solid electrolyte-containing composition according to the embodiment of the present invention is firmly bound to the collector as well. As a result, the sheet for an all-solid state secondary battery according to the embodiment of the present invention is suitably used as a sheet with which a constitutional layer of an all-solid state secondary battery can be formed.

In the sheet for an all-solid state secondary battery according to the embodiment of the present invention, the layer constituted of the inorganic solid electrolyte-containing composition according to the embodiment of the present invention is preferably a layer that is a heat-dried product of the inorganic solid electrolyte-containing composition at a temperature equal to or higher than the crystallization temperature of the polymer binder B in the inorganic solid electrolyte-containing composition, in that the enhancement of the binding property and the reduction of the battery resistance can be realized at a higher level. This heat-dried product is formed of a polymer binder B consisting of a crystalline polymer in which a crystalline component is once melted and then recrystallized, and solid particles bound by the particulate polymer binder A, in the process of forming the constitutional layer (the process of forming a film of the inorganic solid electrolyte-containing composition). As a result, the solid particles are firmly bound to each other without exhibiting an increase in interfacial resistance, and thus it is possible to achieve both the suppression of the increase in the interfacial resistance and the firm binding property between the solid particles at a higher level.

The layer constituted of the inorganic solid electrolyte-containing composition according to the embodiment of the present invention preferably contains 30 or more particulate regions derived from the polymer binder in a cross-sectional region of 10 μm² in any cross section thereof. This particulate region refers to a planar region defined by a polymer binder contained in the layer, where the particulate region is one particulate (lumpy) region that appears in the cross-sectional region, and it is distinguished from a film-shaped region that covers the surface of solid particles. Regarding this particulate region, the kind of the polymer binder is not particularly limited as long as the particulate region is derived from the polymer binder, and examples of the particulate region include a particulate region derived from the polymer binder A and a particulate region derived from the polymer binder B.

In the present invention, in a case where the cross-sectional region includes 30 or more particulate regions, it is possible to effectively reinforce the enhancement of the binding property and the reduction of the interfacial resistance by the polymer binder B. A cross-sectional region of 10 μm² more preferably includes 40 or more particulate regions and still more preferably 50 or more particulate regions in that the suppression of the increase in interfacial resistance and the firm binding property between solid particles can be realized at a higher level. The upper limit of the number of particulate regions is not particularly limited; however, in terms of interfacial resistance, it is preferably 300 or less, more preferably 200 or less, and still more preferably 150 or less in a cross-sectional region of 10 μm². In the present invention, the number of particulate regions can be appropriately adjusted, for example, by changing the content or average particle diameter of the polymer binder, particularly the polymer binder A, among the polymer binders, and by changing the functional group.

The number of particulate regions is observed at a magnification of 10,000 times by cutting the constitutional layer at any cross section plane and then carrying out cross-sectioning by ion milling. This observation is carried out in 10 cross-sectional regions, and the average thereof is taken as the number of particulate regions.

### Condition of Cross-Sectioning by Ion Milling Device

Using an ion milling device (manufactured by Hitachi, Ltd., IM4000PLUS (product name)), a cross-section of the constitutional layer is cut out under conditions of acceleration voltage: 3 kV, discharge voltage: 1.5 V, treatment time: 4 hours, and argon gas flow rate: 0.1 ml/min. The cross section of this constitutional layer is observed with a scanning electron microscope (SEM, product name: JSM-7401F, manufactured by JEOL Ltd.) at a magnification of 10,000 times.

### Observation Conditions and Method of Specifying Particulate Region

In this cross-sectional observation, an image acquired using ImageJ (product name, manufactured by National Institutes of Health (NIH)) is subjected to gray scale conversion and then quaternization to acquire a mapping cross-sectional image. In the obtained image, the contrast is highest in the void portion, followed by the region derived from the binder, then the region derived from the conductive auxiliary agent, and it is lowest in the regions derived from the active material and the solid electrolyte layer. From this mapping cross-sectional image, lumpy regions including positions derived from carbon atoms of the polymer that forms the polymer binder are extracted (regions having the next highest contrast after the void), and the number thereof is counted as the number of particulate regions.

In a case where an all-solid state secondary battery is manufactured using the sheet for an all-solid state secondary battery according to the embodiment of the present invention having the above-described constitution, excellent battery performance (battery resistance and cycle characteristics) is exhibited.

### Manufacturing Method for Sheet for All-Solid State Secondary Battery

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a substrate or a collector (the other layer may be interposed) to form a layer (a coated and dried layer) consisting of an inorganic solid electrolyte-containing composition. This makes it possible to produce a sheet for an all-solid state secondary battery, having a base material or collector, and a coated and dried layer, preferably a coated and dried layer consisting of a heat-dried product of an inorganic solid electrolyte-containing composition. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effects of the present invention do not deteriorate, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be stripped.

### All-Solid State Secondary Battery

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The positive electrode active material layer is preferably formed on a positive electrode collector to configure a positive electrode. The negative electrode active material layer is preferably formed on a negative electrode collector to configure a negative electrode.

It is preferable that at least one of the negative electrode active material layer, the positive electrode active material layer, or the solid electrolyte layer is formed of the inorganic solid electrolyte-containing composition according to the embodiment of the present invention, and an aspect in which all the layers are formed of the inorganic solid electrolyte-containing composition according to the embodiment of the present invention is also preferable. In the active material layer or the solid electrolyte layer formed of the inorganic solid electrolyte-containing composition according to the embodiment of the present invention, the kinds of constitutional components to be contained and the content ratios thereof are preferably the same as the solid content of the inorganic solid electrolyte-containing composition according to the embodiment of the present invention. In a case where the active material layer or the solid electrolyte layer is not formed of the inorganic solid electrolyte-containing composition according to the embodiment of the present invention, a known material in the related art can be used.

The thickness of each of the negative electrode active material layer, the solid electrolyte layer, and the positive electrode active material layer is not particularly limited. In case of taking a dimension of an ordinary all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

### Housing

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being bonded together through a gasket for short circuit prevention.

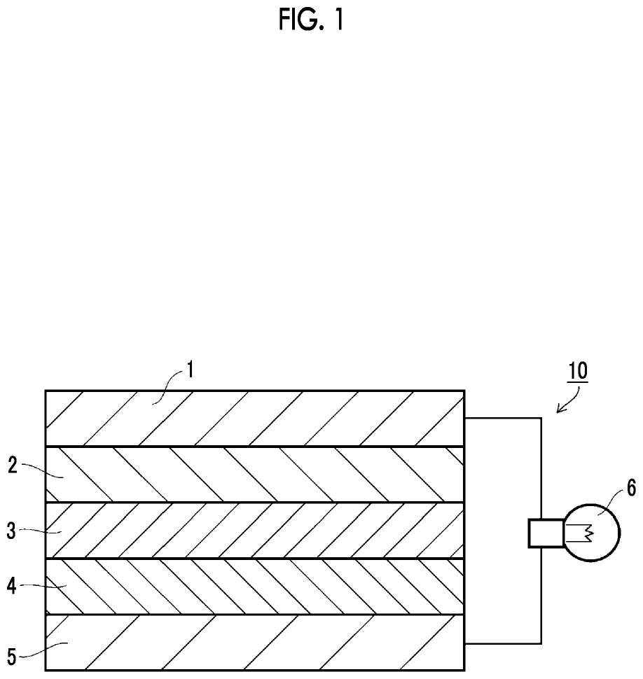

Hereinafter, the all-solid state secondary battery of the preferred embodiments of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In the case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode side return to the positive electrode, and electrons are supplied to an operation portion 6. In an example illustrated in the drawing, an electric bulb is employed as a model at the operation portion 6 and is lit by discharging.

In a case where an all-solid state secondary battery having the layer constitution illustrated in FIG. 1 is put into a 2032-type coin case, the all-solid state secondary battery will be referred to as the electrode sheet for an all-solid state secondary battery, and a battery produced by putting this electrode sheet for an all-solid state secondary battery into the 2032-type coin case will be referred to as the all-solid state secondary battery, thereby referring to both batteries distinctively in some cases.

### Positive Electrode Active Material Layer, Solid Electrolyte Layer, and Negative Electrode Active Material Layer

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 exhibits excellent battery performance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, in the present invention, any one of the positive electrode active material and the negative electrode active material, or collectively both of them may be simply referred to as an active material or an electrode active material.

In the present invention, in a case where the above-described polymer binders A and B are used in combination with solid particles such as an inorganic solid electrolyte or an active material, as described above, the binding property between the solid particles can be made firm while suppressing the increase in the interfacial resistance between the solid particles. Further, the adhesiveness between the solid particles and the collector can be enhanced while suppressing the increase in interfacial resistance. As a result, the all-solid state secondary battery according to the embodiment of the present invention exhibits excellent battery performance (battery resistance and cycle characteristics).

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

The positive electrode collector 5 and the negative electrode collector 1 are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film is formed) obtained by treating the surface of aluminum or stainless steel with carbon, nickel, titanium, or silver is preferable. Among these, aluminum or an aluminum alloy is more preferable.

As a material which forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of fiber.

The thickness of the collector is not particularly limited; however, it is preferably 1 to 500 μm. In addition, protrusions and recesses are preferably provided on the surface of the collector by carrying out a surface treatment.

In the present invention, a functional layer, a functional member, or the like may be appropriately interposed or disposed between each layer of the negative electrode collector, the negative electrode active material layer, the solid electrolyte layer, the positive electrode active material layer, and the positive electrode collector or on the outside thereof. In addition, each layer may be constituted of a single layer or multiple layers.

### Manufacturing Method for All-Solid State Secondary Battery

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Moreover, since the inorganic solid electrolyte-containing composition according to the embodiment of the present invention is excellent in dispersion stability, it is possible to manufacture an all-solid state secondary battery in which the deterioration of battery performance is suppressed even in a case where the preparation of the inorganic solid electrolyte-containing composition and the film formation of each layer are executed uncontinuously temporally (unimmediately after the composition is prepared). As described above, in the present invention, it is possible to manufacture an all-solid state secondary battery that exhibits excellent battery performance and a suitably low electric resistance under the flexible manufacturing conditions. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) including (undergoing) a step of coating an appropriate base material (for example, a metal foil which serves as a collector) with the inorganic solid electrolyte-containing composition according to the embodiment of the present invention and forming a coating film (making a film).

For example, an inorganic solid electrolyte-containing composition containing a positive electrode active material is applied as a material for a positive electrode (a composition for a positive electrode) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a composition for a negative electrode) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector and overlaying a positive electrode collector thereon.

As another method, the following method can be exemplified. That is, the positive electrode sheet for an all-solid state secondary battery is produced as described above. In addition, an inorganic solid electrolyte-containing composition containing a negative electrode active material is applied as a material for a negative electrode onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

The solid electrolyte layer or the like can also be formed by, for example, forming an inorganic solid electrolyte-containing composition or the like on a base material or an active material layer by pressure molding under pressurizing conditions described later.

In the above manufacturing method, It suffices that the inorganic solid electrolyte-containing composition according to the embodiment of the present invention is used in any one of the composition for a positive electrode, the inorganic solid electrolyte-containing composition, and the composition for a negative electrode, and it is preferable that the inorganic solid electrolyte-containing composition according to the embodiment of the present invention is used in all of them.

### Formation of Individual Layer (Film Formation)

The method for applying the inorganic solid electrolyte-containing composition is not particularly limited and can be appropriately selected. Examples thereof include coating (preferably wet-type coating), spray coating, spin coating, dip coating, slit coating, stripe coating, and bar coating.

In this case, the inorganic solid electrolyte-containing composition may be dried after being applied each time or may be dried after being applied multiple times. The drying temperature is not particularly limited. The lower limit is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain good binding property and good ion conductivity even without pressurization.

In the present invention, it is preferable that drying is carried out at a temperature equal to or higher than the crystallization temperature of the polymer that forms the polymer binder B contained in the inorganic solid electrolyte-containing composition in that the suppression of the increase in interfacial resistance and the firm binding property between solid particles can be achieved at a higher level. The drying temperature at this time is not particularly limited as long as it is equal to or higher than the polymer crystallization temperature, and it is appropriately set. For example, the crystallization temperature can be set to +3° C., and further, the crystallization temperature can also be set to +10° C. After heating the inorganic solid electrolyte-containing composition at a predetermined temperature in this manner, it is preferable to carry out cooling by a general method. As a result, the crystalline component of the polymer can be once melted and then recrystallized to make firm the binding property between the solid particles while maintaining the interfacial contact state.

As described above, in a case where the inorganic solid electrolyte-containing composition according to the embodiment of the present invention is applied and dried, a coated and dried layer in which solid particles are firmly bound and the interfacial resistance between the solid particles is low can be formed.

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing method include a method using a hydraulic cylinder pressing machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. On the other hand, in a case where the inorganic solid electrolyte and the polymer binder are present together, the press can be applied at a temperature higher than the glass transition temperature of the polymer binder. However, in general, the temperature does not exceed the melting point of the above-described polymer binder.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out transfer.

The atmosphere during the coating and the pressurization is not particularly limited and may be any one of the atmospheres such as an atmosphere of dried air (the dew point: −20° C. or lower) and an atmosphere of inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the thickness of the portion under pressure. In addition, the pressure may also be variable stepwise for the same portion.

A pressing surface may be flat or roughened.

### Initialization

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

### Use Application of All-Solid State Secondary Battery

The all-solid state secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of the consumer usage thereof include an automobile, an electric vehicle, a motor, a lighting instrument, a toy, a game device, a road conditioner, a watch, a strobe, a camera, and a medical device (a pacemaker, a hearing aid, a shoulder massage device, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto to be interpreted. “Parts” and “%” that represent compositions in the following Examples are mass-based unless particularly otherwise described. In the present invention, “room temperature” means 25° C.

### 1. Synthesis of Polymers Used in Examples and Comparative Examples, and Preparation of Polymer Binder Dispersion Liquid

The (meth)acrylic polymer A (denoted as “Acryl A” in Tables 1, Table 2-1, and Table 2-2) is shown below. However, the content of the constitutional components is omitted.

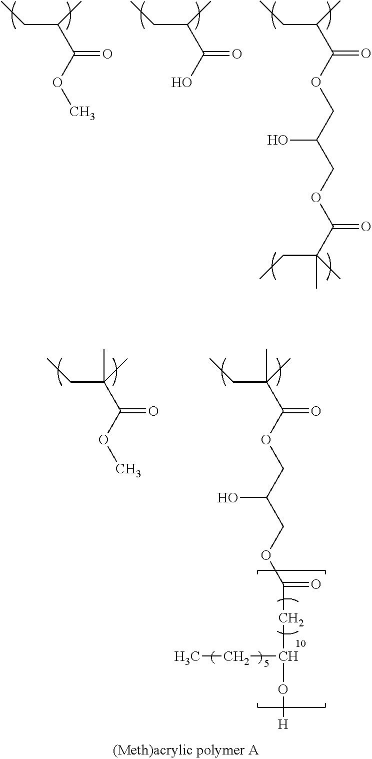

### Synthesis Example 1: Synthesis of (Meth)Acrylic Polymer A and Preparation of Polymer Binder Dispersion Liquid Consisting of Acrylic Polymer A

In a 2L three-necked flask equipped with a reflux condenser and a gas introduction cock, 7.2 g of a heptane solution of 40% by mass of the following macromonomer M-1, 12.4 g of methyl acrylate (MA), and 6.7 g of acrylic acid (AA), 207 g of heptane (manufactured by FUJIFILM Wako Pure Chemical Corporation), and 1.4 g of azoisobutyronitrile were added, nitrogen gas was introduced at a flow rate of 200 mL/min for 10 minutes, and then the temperature was raised to 100° C. A liquid (a liquid obtained by mixing 846 g of the heptane solution of 40% by mass of the macromonomer M-1, 222.8 g of methyl acrylate, 75.0 g of acrylic acid, 300.0 g of heptane, and 2.1 g of azoisobutyronitrile) prepared in a separate container was dropwise added thereto over 4 hours. After the dropwise addition was completed, 0.5 g of azoisobutyronitrile was added thereto. Then, after stirring at 100° C. for 2 hours, the mixture was cooled to room temperature and filtered to obtain a dispersion liquid of a (meth)acrylic polymer A. The solid constitutional component concentration was 39.2%. The SP value of the (meth)acrylic polymer A is 20.0.

### Synthesis Example of Macromonomer M-1

A self-condensate of 12-hydroxystearic acid (manufactured by FUJIFILM Wako Pure Chemical Corporation) (number average molecular weight in GPC polystyrene standard: 2,000) was reacted with glycidyl methacrylate (manufactured by Tokyo Chemical Industry Co., Ltd.) to form a macromonomer, which was subsequently polymerized with methyl methacrylate and glycidyl methacrylate (manufactured by Tokyo Chemical Industry Co., Ltd.) at a ratio of 1:0.99:0.01 (molar ratio) to obtain a polymer, with which acrylic acid (manufactured by FUJIFILM Wako Pure Chemical Corporation) was subsequently reacted to obtain a macromonomer M-1. The SP value of this macromonomer M-1 was 9.3, and the number average molecular weight thereof was 11,000. The SP value and the number average molecular weight of the macromonomer are values calculated according to the above methods.

### Synthesis Example 2: Synthesis of Fluorine-Based Polymer PVDF-HFP1 and Preparation of Polymer Binder Solution Consisting of PVDF-HFP1

A fluorine-based polymer PVDF-HFP1 was synthesized to prepare a binder solution (concentration: 10% by mass) consisting of this fluorine-based polymer.

Specifically, 200 parts by mass of ion exchange water and 100 parts by mass of vinylidene fluoride were added to an autoclave, 1 part by mass of diisopropyl peroxydicarbonate was added, and the mixture was stirred at 30° C. for 24 hours. After completion of the polymerization, 25 parts by mass of hexafluoropropylene and 1 part by mass of diisopropyl peroxydicarbonate were added to the reaction mixture, and the mixture was stirred at 30° C. for 24 hours. After completion of the polymerization in this manner, the precipitate was filtered and dried at 100° C. for 10 hours to obtain PVDF-HFP1 (a polymer binder). The obtained PVDF-HFP1 was dissolved in butyl butyrate to obtain a binder solution.

PVDF-HFP1 is a block copolymer having a copolymerization ratio [PVdF:HFP] (mass ratio)=80:20 of polyvinylidene fluoride (PVdF) to hexafluoropropylene (HFP), and it has an SP value of 11.4.

### Synthesis Example 3: Synthesis of Fluorine-Based Polymer PVDF-HFP2d Preparation of Polymer Binder Solution Consisting of PVDF-HFP2

A fluorine-based polymer PVDF-HFP2 was synthesized in the same manner as PVDF-HFP1 except that the amount of vinylidene fluoride was changed to 93.8 parts by mass and the amount of hexafluoropropylene was changed to 31.3 parts by mass. The obtained PVDF-HFP2 was dissolved in butyl butyrate to obtain a binder solution (concentration: 10% by mass).

PVDF-HFP2 is a block copolymer having a copolymerization ratio [PVdF:HFP] (mass ratio)=75:25 of polyvinylidene fluoride (PVdF) to hexafluoropropylene (HFP), and it has an SP value of 12.0.

### Synthesis Example 4: Synthesis of Fluorine-Based Polymer PVDF-HFP3 and Preparation of Polymer Binder Solution Consisting of PVDF-HFP3

200 parts by mass of ion exchange water, 100 parts by mass of vinylidene fluoride, 25 parts by mass of hexafluoropropylene, and 2 parts by mass of diisopropyl peroxydicarbonate were added to an autoclave, and the resultant mixture was stirred at 70° C. for 24 hours. After completion of the polymerization, the precipitate was filtered and dried at 100° C. for 10 hours to obtain PVDF-HFP3 (a polymer binder). The obtained PVDF-HFP3 was dissolved in butyl butyrate to obtain a binder solution (concentration: 10% by mass).

PVDF-HFP3 is a random copolymer having a copolymerization ratio [PVdF:HFP] (mass ratio)=80:20 of polyvinylidene fluoride (PVdF) to hexafluoropropylene (HFP), and it has an SP value of 11.4.

### Synthesis Example 5: Synthesis of Fluorine-Based Polymer PVDF-HFP4 and Preparation of Polymer Binder Solution Consisting of PVDF-HFP4

PVDF-HFP4 was synthesized in the same manner as in Synthesis Example 2 except that the amount of vinylidene fluoride was changed to 90 parts by mass and the amount of hexafluoropropylene was changed to 10 parts by mass. The obtained PVDF-HFP4 was dissolved in butyl butyrate to obtain a binder solution (concentration: 10% by mass).

PVDF-HFP4 is a block copolymer having a copolymerization ratio [PVdF:HFP] (mass ratio)=90:10 of polyvinylidene fluoride (PVdF) to hexafluoropropylene (HFP), and it has an SP value of 10.2.

### Synthesis Example 6: Synthesis of Fluorine-Based Polymer PVDF-HFPS and Preparation of Polymer Binder Solution Consisting of PVDF-HFP5

PVDF-HFP5 was synthesized in the same manner as in Synthesis Example 2 except that the amount of vinylidene fluoride was changed to 85 parts by mass and the amount of hexafluoropropylene was changed to 15 parts by mass. The obtained PVDF-HFP5 was dissolved in butyl butyrate to obtain a binder solution (concentration: 10% by mass).

PVDF-HFPS is a block copolymer having a copolymerization ratio [PVdF:HFP] (mass ratio)=85:15 of polyvinylidene fluoride (PVdF) to hexafluoropropylene (HFP), and it has an SP value of 10.8.

### Synthesis Example 7: Synthesis of Fluorine-Based Polymer PVDF-HFP6 and Preparation of Polymer Binder Dispersion Liquid Consisting of PVDF-HFP6

200 parts by mass of ion exchange water, 85 parts by mass of vinylidene fluoride were added to an autoclave, 1 part by mass of diisopropyl peroxydicarbonate was added thereto, and the resultant mixture was stirred at 40° C. for 72 hours. After completion of the polymerization, 15 parts by mass of hexafluoropropylene and 1 part by mass of diisopropyl peroxydicarbonate were added to the reaction mixture, and the mixture was stirred at 40° C. for 72 hours. After completion of the polymerization, the precipitate was filtered and dried at 100° C. for 10 hours to obtain PVDF-HFP6 (a polymer binder). The obtained PVDF-HFP6 was dispersed in butyl butyrate to obtain a binder dispersion liquid (concentration: 10% by mass).

PVDF-HFP6 is a block copolymer having a copolymerization ratio [PVdF:HFP] (mass ratio)=85:15 of polyvinylidene fluoride (PVdF) to hexafluoropropylene (HFP), and it has an SP value of 10.8. The average particle diameter of the polymer binder consisting of this polymer in the inorganic solid electrolyte-containing composition was 1.0 μm.

### Synthesis Example 8: Synthesis of Hydrocarbon-Based Polymer CEBC and Preparation of Polymer Binder Solution Consisting of CEBC

A hydrocarbon-based polymer CEBC was synthesized to prepare a binder solution consisting of this hydrocarbon-based polymer.

Specifically, 150 parts by mass of toluene, 60 parts by mass of 1,3-butadiene, 30 parts by mass of ethylene, and 1 part by mass of a polymerization initiator V-601 (manufactured by FUJIFILM Wako Pure Chemical Corporation) were added to an autoclave. Then, the temperature was raised to 80° C., and stirring was carried out for 3 hours. Then, 10 parts by mass of propylene and 1 part by mass of V-601 were added thereto, the temperature was raised to 80° C., and stirring was carried out for 3 hours. Then, the temperature was raised to 90° C., and the reaction was carried out until the conversion rate reached 100%. The obtained solution was reprecipitated in methanol, and the obtained solid was dried to obtain a polymer. The mass average molecular weight of this polymer was 83,000. Then, 50 parts by mass of the polymer obtained above was dissolved in 50 parts by mass of cyclohexane and 150 parts by mass of tetrahydrofuran (THF), and then the solution was brought to 70° C. 3 parts by mass of n-butyl lithium, 3 parts by mass of 2,6-di-t-butyl-p-cresol, 1 part by mass of bis(cyclopentadienyltitanium dichloride, and 2 parts by mass of diethyl aluminum chloride were added thereto, and the resultant mixture was subjected to the reaction at a hydrogen pressure of 10 kg/cm² for 1 hour, distilled off, and dried to obtain SEBS. The mass average molecular weight of CEBC was 83,000.

The obtained CEBS was dissolved in butyl butyrate to prepare a binder solution having a concentration of 10% by mass.

CEBC is a block copolymer having a copolymerization ratio (a mass ratio) of propylene, ethylene, and butylene of 10:30:60, and it has an SP value of 17.0.

### Preparation Example 1: Preparation of Polymer Binder Dispersion Liquid Consisting of Fluorine-Based PVDF

Polyvinylidene difluoride (product name: PVDF, mass average molecular weight: 180,000, manufactured by Sigma Aldrich Co., LLC, SP value: 23.2) was dissolved in butyl butyrate to prepare a polymer binder dispersion liquid having a solid content concentration of 10% by mass.

### Preparation Example 2: Preparation of Polymer Binder Solution Consisting of Hydrocarbon-Based Polymer SEBS

SEBS: A styrene-ethylene-butylene-styrene block copolymer (SEBS, mass average molecular weight 100,000, manufactured by Sigma Aldrich Co., LLC, SP value: 18.0) was dissolved in butyl butyrate to prepare a polymer binder solution having a solid content concentration of 10% by mass.

### Preparation Example 3: Preparation of Polymer Binder Solution Consisting of Hydrocarbon-Based Polymer SBR

SBR: A hydrogenated styrene butadiene rubber (DYNARON1321P (product name), mass average molecular weight 230,000, manufactured by JSR Corporation, SP value: 16.6) was dissolved in butyl butyrate to prepare a polymer binder solution having a solid content concentration of 10% by mass.

### Preparation Example 4: Preparation of Polymer Binder Dispersion Liquid Consisting of Acrylic Fine Particle

180 g of zirconia beads having a diameter of 5 mm was put into a 45 mL container made of zirconia (manufactured by FRITSCH), 5 g of acrylic fine particles (product name: TAFTIC FH-5005) and 45 g of butyl butyrate were put thereinto, and the resultant mixture was set in a planetary ball mill P-7 made by FRITSCH. The mixture was mixed at a temperature of 25° C. and a rotation speed of 200 rpm for 15 minutes to prepare a polymer binder dispersion liquid consisting of acrylic fine particles having a solid content concentration of 10% by mass.

Table 1 shows the presence or absence of crystalline component, crystallization temperature, and mass average molecular weight of each polymer that forms the polymer binder. The mass average molecular weight of each of the polymers was measured by the above method (the conditions 2). The crystallization temperature of each polymer binder was measured by the above method.

TABLE 1

| | Presence or | | Mass |
|---|---|---|---|
| | absence of | Crystallization | average |
| | crystalline | temperature | molecular |
| Polymer | component | (° C.) | weight |
| Acryl A | Absent | — | 90,000 |
| PVDF-HFP4 | Present | 56 | 320,000 |
| PVDF-HFP5 | Present | 64 | 330,000 |
| PVDF-HFP6 | Present | 64 | 300,000 |
| PVDF-HFP1 | Present | 95 | 400,000 |
| PVDF-HFP2 | Present | 130 | 200,000 |
| PVDF-HFP3 | Absent | — | 180,000 |
| CEBC | Present | 130 | 83,000 |
| PVDF | Absent | — | 180,000 |
| SEBS | Absent | — | 100,000 |
| SBR | Absent | — | 230,000 |

For each of the prepared polymer binders, the adsorption rate (A_{SE}) with respect to the inorganic solid electrolyte shown in Table 2-1 and Table 2-2 (collectively referred to as Table 2), the adsorption rate (A_{AM}) with respect to the active material (the active material used in the preparation of the composition) shown in Table 2, the solubility in the non-polar dispersion medium, and the peel strength with respect to the copper foil or aluminum foil were measured by the following methods. Further, the average particle diameter of the particulate polymer binder was measured by the above method. The results are shown in Table 2.

### Synthesis Example A: Synthesis of Sulfide-Based Inorganic Solid Electrolyte

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Sigma Aldrich Co., LLC Co., LLC, purity: >99.98%) (2.42 g) and diphosphorus pentasulfide (P₂S₅, manufactured by Sigma Aldrich Co., LLC Co., LLC, purity: >99%) (3.90 g) each were weighed, put into an agate mortar, and mixed using an agate muddler for 5 minutes. The mixing ratio between Li₂S and P₂S₅ (Li₂S:P₂S₅) was set to 75:25 in terms of molar ratio.

66 g of zirconia beads having a diameter of 5 mm were put into a 45 mL zirconia container (manufactured by FRITSCH), the entire amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). The average particle diameter of the Li—P—S-based glass was 2.5

### Measurement of Adsorption Rate ASE of Polymer Binder with Respect to Inorganic Solid Electrolyte

0.5 g of the inorganic solid electrolyte (LPS) and 0.26 g of the polymer binder used in the preparation of each of the inorganic solid electrolyte-containing compositions shown in Table 2 were placed in a 15 mL vial, 25 g of butyl butyrate was added thereto while stirring with a mixing rotor, and further, the mixture was stirred at 80 rpm for 30 minutes at room temperature. The stirred dispersion liquid was filtered through a filter having a pore diameter of 1 μm, 2 g of the filtrate was dried, and the mass BX of the dried polymer binder (the mass of the polymer binder which had not adsorbed to the inorganic solid electrolyte) was measured.

From the mass BX of the polymer binder obtained as described above and the mass of 0.26 g of the polymer binder used, the adsorption rate of the polymer binder with respect to the inorganic solid electrolyte was calculated according to the following expression.

The adsorption rate AsE of the polymer binder is the average value of the adsorption rates obtained by carrying out the above measurement twice.

$$Adsorption rate ( \% ) = [ ( 0.26 - BX \times 25 / 2 ) / 0.26 ] \times 100$$

As a result of measuring the adsorption rate AsE using the inorganic solid electrolyte and the polymer binder extracted from the inorganic solid electrolyte layer which had been subjected to the film formation, the same value was obtained.

### Measurement of Adsorption Rate A_{AM} of Polymer Binder with Respect to Active Material

1.6 g of the active material used in the preparation of each of the inorganic solid electrolyte-containing compositions (the composition for an electrode) shown in Table 2 and 0.08 g of the polymer binder used were placed in a 15 mL vial, 8 g of butyl butyrate was added thereto while stirring with a mixing rotor, and further, the mixture was stirred at 80 rpm for 30 minutes at room temperature. The stirred dispersion liquid was filtered through a filter having a pore diameter of 1 μm, 2 g of the filtrate was dried, and the mass of the dried polymer binder (the mass of the polymer binder which had not adsorbed to the active material), the mass BY, was measured.

From the mass BY of the polymer binder obtained as described above and the mass of 0.08 g of the polymer binder used, the adsorption rate of the polymer binder with respect to the active material was calculated according to the following expression.

The adsorption rate A_{AM} of the polymer binder is the average value of the adsorption rates obtained by carrying out the above measurement twice.

$$Adsorption rate ( \% ) = [ ( 0 \text{.08} - BY \times 8 / 2 ) / 0.08 ] \times 100$$

As a result of measuring the adsorption rate A_{AM} using the active material and the polymer binder extracted from the active material layer which had been subjected to the film formation, the same value was obtained.

### Measurement of Solubility in Non-Polar Dispersion Medium

A specified amount of each polymer binder was weighed in a glass bottle, 100 g of butyl butyrate was added thereto, and the mixture was stirred on a mixing rotor at a rotation speed of 80 rpm for 24 hours at a temperature of 25° C. After stirring for 24 hours, the obtained mixed solution was subjected to the transmittance measurement under the following conditions.

This test (the transmittance measurement) is carried out by changing the amount of the polymer binder dissolved, and the upper limit concentration X (% by mass) at which the transmittance is 99.8% is defined as the solubility of the polymer binder in the non-polar dispersion medium.

### Transmittance Measurement Conditions

Dynamic light scattering (DLS) measurement

Device: DLS measuring device DLS-8000 manufactured by Otsuka Electronics Co., Ltd.

Laser wavelength, output: 488 nm/100 mW

Sample cell: NMR tube

### Measurement of Peel Strength (90° Peeling Test) with Respect to Collector (Copper Foil or Aluminum Foil)

A solution (solid content concentration: 10% by mass), in which each polymer binder had been dissolved in a dispersion medium (DIBK), was added dropwise onto a copper foil (trade name: C1100, manufactured by Hohsen Corp.) or an aluminum foil (trade name: A1N30, manufactured by Hohsen Corp.) and then dried (temperature: 100° C., time: 180 minutes) to produce a dried film (width: 10 mm, length: 50 mm) having a thickness of 50 μm.

An average peeling force measured by using a tensile tester (ZTS-50N, manufactured by IMADA Co., Ltd.) when the obtained dried film was peeled off at a speed of 30 mm/s and an angle of 90° with respect to the coated surface of the copper foil was adopted as the peel strength (unit: N/mm).

It is noted that for the polymer binders used in the positive electrode compositions P-1 to P-21, the peel strength with respect to the aluminum foil was measured, and for the polymer binders used in the compositions N-1 to N-4 for a negative electrode, the peel strength with respect to the copper was measured.

### Example 1

In Example 1, an inorganic solid electrolyte-containing composition, a composition for a negative electrode layer, and a composition for a positive electrode layer were prepared using the formed or prepared polymer binder, and the dispersibility thereof was evaluated.

### Preparation of Composition No. P-1 for Positive Electrode

160 g of zirconia beads having a diameter of 5 mm were put into a 45 mL container made of zirconia (manufactured by FRITSCH), and then 2.09 g of LPS synthesized in Synthesis Example A, and 12.3 g of butyl butyrate as a dispersion medium were put thereinto. The container was set in a planetary ball mill P-7 manufactured by FRITSCH, and mixing was carried out at a temperature of 25° C. and a rotation speed of 300 rpm for 2 hours. Then, 7.11 g of NMC (LiNi_{1/3}Co_{1/3}Mn_{1/3}O₂, average particle diameter: 3.0 μm) as the active material, 0.19 g of acetylene black, 0.047 g (in terms of solid contents) of a binder dispersion liquid of acrylic fine particles (product name: TAFTIC FH-5005) as the polymer binder A, and 0.047 g (in terms of solid contents) of the binder solution of PVDF-HFP1 prepared in Synthesis Example 2 as the polymer binder B were put into a container. Similarly, the container was set in a planetary ball mill P-7, and mixing was continued at a temperature of 25° C. and a rotation speed of 200 rpm for 15 minutes. In this manner, a composition (slurry) No. P-1 for a positive electrode was prepared.

### Preparation of Compositions Nos. P-2 to P-21 for Positive Electrode

Each of compositions Nos. P-2 to P-21 for a positive electrode was prepared in the same manner as in the preparation of the composition No. P-1 for a positive electrode, except that in the preparation of the composition No. P-1 for a positive electrode, the dispersion liquid or content (solid content) of the polymer binder A and the solution or content (solid content) of the polymer binder B, as well as the inorganic solid electrolyte and the dispersion medium, the active material, and the like, were changed to those shown Table 2.

### Preparation of Inorganic Solid Electrolyte-Containing Composition No. S-2

180 g of zirconia beads having a diameter of 5 mm were put into a 45 mL container made of zirconia (manufactured by FRITSCH), and then 1.93 g of LPS synthesized in Synthesis Example A, and 12.3 g of butyl butyrate as a dispersion medium were put thereinto. Then, 0.03 g (in terms of solid contents) of a binder dispersion liquid of acrylic fine particles (product name: TAFTIC FH-S005) as the polymer binder A, and 0.03 g (in terms of solid contents) of the binder solution of PVDF-HFP1 prepared in Synthesis Example 2 as the polymer binder B were put into a container, and the container was set in a planetary ball mill P-7 manufactured by FRITSCH. Mixing was carried out at a temperature of 25° C. and a rotation speed of 200 rpm for 15 minutes to prepare an inorganic solid electrolyte-containing composition No. S-2.

### Preparation of Inorganic Solid Electrolyte-Containing Composition Nos. S-1, S-3, and S-4

Each of inorganic solid electrolyte-containing compositions Nos. S-1, S-3, and S-4 was prepared in the same manner as in the preparation of the inorganic solid electrolyte-containing composition No. S-2, except that in the preparation of the inorganic solid electrolyte-containing composition No. S-2, the dispersion liquid or content (solid content) of the polymer binder A, the solution or content (solid content) of the polymer binder B, and the like were changed to those shown in Table 2.

### Preparation of Composition (Slurry) No. N-2 for Negative Electrode

180 g of zirconia beads having a diameter of 5 mm were put into a 45 mL container made of zirconia (manufactured by FRITSCH), and then 2.90 g of LPS synthesized in Synthesis Example A, and 12.3 g of butyl butyrate as a dispersion medium were put thereinto. The container was set in a planetary ball mill P-7 manufactured by FRITSCH, and mixing was carried out at a temperature of 25° C. and a rotation speed of 300 rpm for 2 hours. Then, 3.50 g of Si (trade name, Silicon Powder, average particle diameter: 1 to 5 μm, manufactured by Thermo Fisher Scientific, Inc.) as the active material, 0.27 g of acetylene black (trade name, AB powder, manufactured by Denka Company Limited) as the conductive auxiliary agent, 0.034 g (in terms of solid contents) of the binder dispersion liquid of acrylic fine particles (product name: TAFTIC FH-5005) as the polymer binder A, and 0.034 g (in terms of solid contents) of the binder dispersion liquid of PVDF-HFP1 prepared in Synthesis Example 2 as the polymer binder B, were put into a container. Similarly, the container was set in a planetary ball mill P-7, and mixing was carried out at a temperature of 25° C. and a rotation speed of 200 rpm for 15 minutes to obtain a composition No. N-2 for a negative electrode.

### Preparation of Composition Nos. N-1, N-3, and N-4 for Negative Electrode

Each of compositions Nos. N-1, N-3, and N-4 for a negative electrode was prepared in the same manner as in the preparation of the composition No. N-2 for a negative electrode, except that in the preparation of the composition No. N-2 for a negative electrode, the dispersion liquid or content (solid content) of the polymer binder A, the solution or content (solid content) of the polymer binder B, and the like were changed to those shown in Table 2.

TABLE 2-1

| | | | Polymer binder A | | | | | | | | | | | | | | |
|---|---|---|---|---|---|---|---|---|---|---|---|---|---|---|---|---|---|
| | | | | | | | Average | | | | Polymer binder B | | | | | | |
| | | | | | | Solu- | particle | Mor- | Peel | | Con- | SP | | | Solu- | Mor- | Peel |
| No. | Layer | Kind | Content | A_{SE} | A_{AM} | bility | diameter | phology | strength | Kind | tent | value | A_{SE} | A_{AM} | bility | phology | strength |
| P-1 | Posi- | Acrylic | 0.5 | 80 | 95 | <0.01 | 0.8 μm | Partic- | 0.4 | PVDF- | 0.5 | 11.4 | 0 | 10 | 10 | Solu- | 0.3 |
| | tive | fine | | | | | | ulate | | HFP1 | | | | | | ble | |
| | elec- | particle | | | | | | | | | | | | | | type | |
| | trode | | | | | | | | | | | | | | | | |
| P-2 | Posi- | — | — | — | — | — | — | Partic- | — | PVDF- | 0.5 | 11.4 | 0 | 10 | 10 | Solu- | 0.3 |
| | tive | | | | | | | ulate | | HFP1 | | | | | | ble | |
| | elec- | | | | | | | | | | | | | | | type | |
| | trode | | | | | | | | | | | | | | | | |
| P-3 | Posi- | — | — | — | — | — | — | Partic- | — | PVDF- | 1.0 | 11.4 | 0 | 10 | 10 | Solu- | 0.3 |
| | tive | | | | | | | ulate | | HFP1 | | | | | | ble | |
| | elec- | | | | | | | | | | | | | | | type | |
| | trode | | | | | | | | | | | | | | | | |
| P-4 | Posi- | Acrylic | 0.5 | 80 | 95 | <0.01 | 0.8 μm | Partic- | 0.4 | — | — | — | — | — | — | — | — |
| | tive | fine | | | | | | ulate | | | | | | | | | |
| | elec- | particle | | | | | | | | | | | | | | | |
| | trode | | | | | | | | | | | | | | | | |
| P-5 | Posi- | Acrylic | 0.5 | 80 | 95 | <0.01 | 0.8 μm | Partic- | 0.4 | PVDF- | 0.5 | 12.0 | 0 | 10 | 10 | Solu- | 0.4 |
| | tive | fine | | | | | | ulate | | HFP2 | | | | | | ble | |
| | elec- | particle | | | | | | | | | | | | | | type | |
| | trode | | | | | | | | | | | | | | | | |
| P-6 | Posi- | Acrylic | 0.5 | 80 | 95 | <0.01 | 0.8 μm | Partic- | 0.4 | PVDF- | 0.5 | 12.0 | 0 | 10 | 10 | Solu- | 0.4 |
| | tive | fine | | | | | | ulate | | HFP2 | | | | | | ble | |
| | elec- | particle | | | | | | | | | | | | | | type | |
| | trode | | | | | | | | | | | | | | | | |
| P-7 | Posi- | Acrylic | 0.5 | 80 | 95 | <0.01 | 0.8 μm | Partic- | 0.4 | CEBC | 0.5 | 17.0 | 0 | 10 | 4 | Solu- | 0.5 |
| | tive | fine | | | | | | ulate | | | | | | | | ble | |
| | elec- | particle | | | | | | | | | | | | | | type | |
| | trode | | | | | | | | | | | | | | | | |
| P-8 | Posi- | Acrylic | 0.5 | 80 | 95 | <0.01 | 0.8 μm | Partic- | 0.4 | CEBC | 0.5 | 17.0 | 0 | 10 | 4 | Solu- | 0.5 |
| | tive | fine | | | | | | ulate | | | | | | | | ble | |
| | elec- | particle | | | | | | | | | | | | | | type | |
| | trode | | | | | | | | | | | | | | | | |
| P-9 | Posi- | Acrylic | 0.5 | 80 | 95 | <0.01 | 0.8 μm | Partic- | 0.4 | SEBS | 0.5 | 18.0 | 0 | 10 | 10 | Solu- | 0.3 |
| | tive | fine | | | | | | ulate | | | | | | | | ble | |
| | elec- | particle | | | | | | | | | | | | | | type | |
| | trode | | | | | | | | | | | | | | | | |
| P-10 | Posi- | Acrylic | 0.5 | 80 | 95 | <0.01 | 0.8 μm | Partic- | 0.4 | PVDF- | 0.5 | 12.1 | 0 | 10 | 10 | Solu- | 0.4 |
| | tive | fine | | | | | | ulate | | HFP3 | | | | | | ble | |
| | elec- | particle | | | | | | | | | | | | | | type | |
| | trode | | | | | | | | | | | | | | | | |
| P-11 | Posi- | PVDF | 0.5 | 0 | 0 | <0.01 | 1.0 μm | Partic- | 0.4 | PVDF- | 0.5 | 11.4 | 0 | 10 | 10 | Solu- | 0.4 |
| | tive | | | | | | | ulate | | HFP1 | | | | | | ble | |
| | elec- | | | | | | | | | | | | | | | type | |
| | trode | | | | | | | | | | | | | | | | |
| P-12 | Posi- | PVDF | 0.5 | 0 | 0 | <0.01 | 1.0 μm | Partic- | 0.4 | SBR | 0.5 | 16.6 | 0 | 10 | 10 | Solu- | 0.4 |
| | tive | | | | | | | ulate | | | | | | | | ble | |
| | elec- | | | | | | | | | | | | | | | type | |
| | trode | | | | | | | | | | | | | | | | |
| P-13A | Posi- | PVDF | 0.5 | 0 | 0 | <0.01 | 1.0 μm | Partic- | 0.4 | SBR | 0.5 | 16.6 | 0 | 10 | 10 | Solu- | 0.4 |
| | tive | | | | | | | ulate | | | | | | | | ble | |
| | elec- | | | | | | | | | | | | | | | type | |
| | trode | | | | | | | | | | | | | | | | |
| P-13B | Posi- | PVDF | 5.0 | 0 | 0 | <0.01 | 1.0 μm | Partic- | 0.4 | SBR | 1.0 | 16.6 | 0 | 10 | 10 | Solu- | 0.4 |
| | tive | | | | | | | ulate | | | | | | | | ble | |
| | elec- | | | | | | | | | | | | | | | type | |
| | trode | | | | | | | | | | | | | | | | |
| P-14 | Posi- | Acryl | 0.5 | 80 | 95 | <0.01 | 0.2 μm | Partic- | 0.7 | CEBC | 0.5 | 17.0 | 0 | 10 | 4 | Solu- | 0.5 |
| | tive | A | | | | | | ulate | | | | | | | | ble | |
| | elec- | | | | | | | | | | | | | | | type | |
| | trode | | | | | | | | | | | | | | | | |
| P-15 | Posi- | Acrylic | 0.5 | 80 | 95 | <0.01 | 0.8 μm | Partic- | 0.4 | PVDF- | 0.5 | 11.4 | 0 | 10 | 10 | Solu- | 0.4 |
| | tive | fine | | | | | | ulate | | HFP4 | | | | | | ble | |
| | elec- | particle | | | | | | | | | | | | | | type | |
| | trode | | | | | | | | | | | | | | | | |
| P-16 | Posi- | Acrylic | 0.5 | 80 | 95 | <0.01 | 0.8 μm | Partic- | 0.4 | PVDF- | 0.5 | 11.4 | 0 | 10 | 10 | Solu- | 0.4 |
| | tive | fine | | | | | | ulate | | HFP5 | | | | | | ble | |
| | elec- | particle | | | | | | | | | | | | | | type | |
| | trode | | | | | | | | | | | | | | | | |
| P-17 | Posi- | Acrylic | 0.5 | 80 | 95 | <0.01 | 0.8 μm | Partic- | 0.4 | PVDF- | 0.5 | 11.4 | 0 | 10 | 0.05 | Partic- | 0.4 |
| | tive | fine | | | | | | ulate | | HFP6 | | | | | | ulate | |
| | elec- | particle | | | | | | | | | | | | | | | |
| | trode | | | | | | | | | | | | | | | | |
| P-18 | Posi- | PVDF- | 0.5 | 80 | 95 | 10 | — | Soluble | 0.4 | PVDF- | 0.5 | 12.0 | 0 | 10 | 10 | Solu- | 0.4 |
| | tive | HFP1 | | | | | | type | | HFP2 | | | | | | ble | |
| | elec- | | | | | | | | | | | | | | | type | |
| | trode | | | | | | | | | | | | | | | | |
| P-19 | Posi- | Acrylic | 0.2 | 80 | 95 | <0.01 | 0.8 μm | Partic- | 0.4 | PVDF- | 0.8 | 12.0 | 0 | 10 | 10 | Solu- | 0.4 |
| | tive | fine | | | | | | ulate | | HFP2 | | | | | | ble | |
| | elec- | particle | | | | | | | | | | | | | | type | |
| | trode | | | | | | | | | | | | | | | | |
| P-20 | Posi- | Acryl | 0.5 | 70 | 95 | <0.01 | 0.2 μm | Partic- | 0.7 | CEBC | 0.5 | 17.0 | 0 | 10 | 4 | Solu- | 0.5 |
| | tive | A | | | | | | ulate | | | | | | | | ble | |
| | elec- | | | | | | | | | | | | | | | type | |
| | trode | | | | | | | | | | | | | | | | |
| P-21 | Posi- | Acryl | 0.5 | 80 | 95 | <0.01 | 0.2 μm | Partic- | 0.7 | CEBC | 0.5 | 17.0 | 0 | 10 | 4 | Solu- | 0.5 |
| | tive | A | | | | | | ulate | | | | | | | | ble | |
| | elec- | | | | | | | | | | | | | | | type | |
| | trode | | | | | | | | | | | | | | | | |
| S-1 | SE | — | — | — | — | — | — | — | — | PVDF- | 3.0 | 11.4 | 0 | 10 | 10 | Solu- | — |
| | | | | | | | | | | HFP1 | | | | | | ble | |
| | | | | | | | | | | | | | | | | type | |
| S-2 | SE | Acrylic | 1.5 | 80 | 95 | <0.01 | 0.8 μm | Partic- | — | PVDF- | 1.5 | 11.4 | 0 | 10 | 10 | Solu- | — |
| | | fine | | | | | | ulate | | HFP1 | | | | | | ble | |
| | | particle | | | | | | | | | | | | | | type | |
| S-3 | SE | Acryl | 1.5 | 80 | 95 | <0.01 | 0.2 μm | Partic- | — | PVDF- | 1.5 | 11.4 | 0 | 10 | 10 | Solu- | — |
| | | A | | | | | | ulate | | HFP1 | | | | | | ble | |
| | | | | | | | | | | | | | | | | type | |
| S-4 | SE | Acryl | 1.5 | 80 | 95 | <0.01 | 0.2 μm | Partic- | — | PVDF- | 1.5 | 12.0 | 0 | 10 | 10 | Solu- | — |
| | | A | | | | | | ulate | | HFP2 | | | | | | ble | |
| | | | | | | | | | | | | | | | | type | |
| N-1 | Nega- | — | — | — | — | — | — | — | — | PVDF- | 1.0 | 11.4 | 0 | 10 | 10 | Solu- | 0.2 |
| | tive | | | | | | | | | HFP1 | | | | | | ble | |
| | elec- | | | | | | | | | | | | | | | type | |
| | trode | | | | | | | | | | | | | | | | |
| N-2 | Nega- | Acrylic | 0.5 | 80 | 95 | <0.01 | 0.8 μm | Partic- | 0.2 | PVDF- | 0.5 | 11.4 | 0 | 10 | 10 | Solu- | 0.2 |
| | tive | fine | | | | | | ulate | | HFP1 | | | | | | ble | |
| | elec- | particle | | | | | | | | | | | | | | type | |
| | trode | | | | | | | | | | | | | | | | |
| N-3 | Nega- | Acryl | 0.5 | 80 | 95 | <0.01 | 0.2 μm | Partic- | 0.5 | PVDF- | 0.5 | 11.4 | 0 | 10 | 10 | Solu- | 0.2 |
| | tive | A | | | | | | ulate | | HFP1 | | | | | | ble | |
| | elec- | | | | | | | | | | | | | | | type | |
| | trode | | | | | | | | | | | | | | | | |
| N-4 | Nega- | Acryl | 0.5 | 80 | 95 | <0.01 | 0.2 μm | Partic- | 0.5 | PVDF- | 0.5 | 12.0 | 0 | 10 | 10 | Solu- | 0.3 |
| | tive | A | | | | | | ulate | | HFP2 | | | | | | ble | |
| | elec- | | | | | | | | | | | | | | | type | |
| | trode | | | | | | | | | | | | | | | | |

TABLE 2-2

| | | | | | | | conductive | | | | |
|---|---|---|---|---|---|---|---|---|---|---|---|
| | Inorganic solid | | Dispersion medium | | Active material | | auxiliary agent | | | Drying | |
| | electrolyte | | | SP | | SP | | SP | | temperature | |
| No. | Kind | Content | Kind | value | Kind | value | Kind | value | Pieces | (° C.) | Note |
| P-1 | LPS | 22 | Butyl | 18.6 | NMC | 75 | AB | 2 | 43 | 100 | Present |
| | | | butyrate | | | | | | | | invention |
| P-2 | LPS | 22.5 | Butyl | 18.6 | NMC | 75 | AB | 2 | — | 100 | Comparative |
| | | | butyrate | | | | | | | | Example |
| P-3 | LPS | 22 | Butyl | 18.6 | NMC | 75 | AB | 2 | — | 100 | Comparative |
| | | | butyrate | | | | | | | | Example |
| P-4 | LPS | 22.5 | Butyl | 18.6 | NMC | 75 | AB | 2 | 43 | 100 | Comparative |
| | | | butyrate | | | | | | | | Example |
| P-5 | LPS | 22 | Butyl | 18.6 | NMC | 75 | AB | 2 | 43 | 100 | Present |
| | | | butyrate | | | | | | | | invention |
| P-6 | LPS | 22 | Butyl | 18.6 | NMC | 75 | AB | 2 | 43 | 135 | Present |
| | | | butyrate | | | | | | | | invention |
| P-7 | LPS | 22 | Butyl | 18.6 | NMC | 75 | AB | 2 | 43 | 100 | Present |
| | | | butyrate | | | | | | | | invention |
| P-8 | LPS | 22 | Butyl | 18.6 | NMC | 75 | AB | 2 | 43 | 135 | Present |
| | | | butyrate | | | | | | | | invention |
| P-9 | LPS | 22 | Butyl | 18.6 | NMC | 75 | AB | 2 | 43 | 100 | Comparative |
| | | | butyrate | | | | | | | | Example |
| P-10 | LPS | 22 | Butyl | 18.6 | NMC | 75 | AB | 2 | 43 | 100 | Comparative |
| | | | butyrate | | | | | | | | Example |
| P-11 | LPS | 22 | Butyl | 18.6 | NMC | 75 | AB | 2 | 38 | 100 | Present |
| | | | butyrate | | | | | | | | invention |
| P-12 | LPS | 22 | Butyl | 18.6 | NMC | 75 | AB | 2 | 38 | 100 | Comparative |
| | | | butyrate | | | | | | | | Example |
| P-13A | LPS | 22 | Xylene | 18.0 | NMC | 75 | AB | 2 | 38 | 100 | Comparative |
| | | | | | | | | | | | Example |
| P-13B | LPS | 17 | Xylene | 18.0 | NMC | 75 | AB | 2 | 38 | 100 | Comparative |
| | | | | | | | | | | | Example |
| P-14 | LPS | 22 | Butyl | 18.6 | NMC | 75 | AB | 2 | 70 | 135 | Example |
| | | | butyrate | | | | | | | | |
| P-15 | LPS | 22 | Butyl | 18.6 | NMC | 75 | AB | 2 | 43 | 100 | Comparative |
| | | | butyrate | | | | | | | | Example |
| P-16 | LPS | 22 | Butyl | 18.6 | NMC | 75 | AB | 2 | 43 | 100 | Present |
| | | | butyrate | | | | | | | | invention |
| P-17 | LPS | 22 | Butyl | 18.6 | NMC | 75 | AB | 2 | 43 | 100 | Present |
| | | | butyrate | | | | | | | | invention |
| P-18 | LPS | 22 | Butyl | 18.6 | NMC | 75 | AB | 2 | — | 100 | Comparative |
| | | | butyrate | | | | | | | | Example |
| P-19 | LPS | 22 | Butyl | 18.6 | NMC | 75 | AB | 2 | 20 | 135 | Present |
| | | | butyrate | | | | | | | | invention |
| P-20 | LLZ | 22 | Butyl | 18.6 | NMC | 75 | AB | 2 | 70 | 135 | Present |
| | | | butyrate | | | | | | | | invention |
| P-21 | LPS | 22 | Butyl | 18.6 | NCA | 75 | AB | 2 | 70 | 135 | Present |
| | | | butyrate | | | | | | | | invention |
| S-1 | LPS | 97 | Butyl | 18.6 | — | — | — | — | — | 100 | Comparative |
| | | | butyrate | | | | | | | | Example |
| S-2 | LPS | 97 | Butyl | 18.6 | — | — | — | — | 43 | 100 | Example |
| | | | butyrate | | | | | | | | |
| S-3 | LPS | 97 | Butyl | 18.6 | — | — | — | — | 70 | 100 | Example |
| | | | butyrate | | | | | | | | |
| S-4 | LPS | 97 | Butyl | 18.6 | — | — | — | — | 70 | 135 | Example |
| | | | butyrate | | | | | | | | |
| N-1 | LPS | 43 | Butyl | 18.6 | Si | 52 | AB | 4 | — | 100 | Comparative |
| | | | butyrate | | | | | | | | Example |
| N-2 | LPS | 43 | Butyl | 18.6 | Si | 52 | AB | 4 | 43 | 100 | Example |
| | | | butyrate | | | | | | | | |
| N-3 | LPS | 43 | Butyl | 18.6 | Si | 52 | AB | 4 | 70 | 100 | Example |
| | | | butyrate | | | | | | | | |
| N-4 | LPS | 43 | Butyl | 18.6 | Si | 52 | AB | 4 | 70 | 135 | Example |
| | | | butyrate | | | | | | | | |

### Abbreviation in Table

In the table, “-” indicates that the corresponding constitutional component is not contained.

The units of the content and the solubility are “% by mass”.

The units of the adsorption rates A_{SE} and A_{AM} are “%”, the unit of average particle diameter is “μm”, the unit of peel strength is “N/mm”, the unit of SP value is “MPa^{1/2}”, and the unit of the number is “pieces/10 μm²”.

In the column of “Layer”, “Negative electrode” indicates a composition for a negative electrode, “Positive electrode” indicates a composition for a positive electrode, and “SE” indicates an inorganic solid electrolyte-containing composition.

LPS: Li—P—S-based glass (sulfide-based inorganic solid electrolyte) synthesized in Synthesis Example A

LLZ: Li₇La₃Zr₂O₁₂ (oxide-based inorganic solid electrolyte)

Acrylic fine particle: TAFTIC FH-S005 (product name, average particle diameter: 5 μm, manufactured by TOYOBO Co., Ltd.), without crystalline component, mass average molecular weight 130,000, SP value: 20 MPa^{1/2}

Acryl A: (Meth)acrylic polymer A synthesized in Synthesis Example 1

PVDF: Polyvinylidene fluoride manufactured by Sigma Aldrich Co., LLC)

PVDF-HEP1: PVDF-HEP1 synthesized in Synthesis Example 2

PVDF-HFP2: PVDF-HEP2 synthesized in Synthesis Example 3

PVDF-HFP3: PVDF-HEP3 synthesized in Synthesis Example 4

PVDF-HFP4: PVDF-HEP4 synthesized in Synthesis Example 5

PVDF-HFP5: PVDF-HEP5 synthesized in Synthesis Example 6

PVDF-HFP6: PVDF-HEP6 synthesized in Synthesis Example 7

CEBC: CEBC synthesized in Synthesis Example 8

SEBS: Styrene-ethylene-butylene-styrene block copolymer (manufactured by Sigma Aldrich Co., LLC)

SBR: Hydrogenated styrene-butadiene rubber (manufactured by JSR Corporation)

In the column of “Morphology” of the polymer binder A and the polymer binder B, the state of the polymer binder in the inorganic solid electrolyte-containing composition is indicated. Specifically, a case where a polymer binder is dispersed in a solid state in a dispersion medium (a case of a particulate polymer binder) is written as “Particulate”, and a case where a polymer binder is dissolved in a dispersion medium (a case of a soluble type polymer binder) is written as “Soluble type”.

NMC: LiNi1/3Co1/3Mn1/3O2 (lithium nickel manganese cobalt oxide)

NCA: LiNi_{0.85}Co_{0.10}Al_{0.05}O₂ (lithium nickel cobalt aluminum oxide)

Si: Silicon Powder (trade name, particle diameter: 1 to 5 μm, manufactured by Thermo Fisher Scientific, Inc.)

The initial dispersibility of each of the prepared compositions was evaluated.

Each composition was placed in a sedimentation tube having an inner diameter of 5 mm and allowed to stand at 25° C. for 24 hours, and then the distance X of the interface between the clear fraction (the supernatant) separated from the composition and the composition (which is in a state where the dispersed state is maintained after the clear fraction separation) was measured. Specifically, in a case where the distance from the bottom surface of the sedimentation tube to the surface of the clear fraction layer (the surface of the placed composition) was set to 100, the distance X from the bottom surface to the interface was calculated in terms of percentage, and the evaluation was carried out by determining which of the following evaluation standards included the calculated value. The results are shown in Table 3. In the test, in a case where the evaluation of the initial dispersibility is evaluation rank “C” or higher, the dispersibility of the composition (the dispersibility of the solid particles) is excellent, which is preferable.

### Evaluation Rank

AA: 98% or more and 100% or less

A: 95% or more and less than 98%

B: 90% or more and less than 95%

C: 85% or more and less than 90%

D: less than 85%

### Evaluation of Dispersion Stability of Composition

The dispersion stability of each of the prepared compositions was evaluated.

Each composition was placed in a sedimentation tube having an inner diameter of 5 mm and allowed to stand at 25° C. for 72 hours, the distance X of the interface between the clear fraction (the supernatant) separated from the composition and the composition (which is in a state where the dispersed state is maintained after the clear fraction separation) was measured, and the dispersion stability was evaluated according to the same evaluation standards as the initial dispersibility. The results are shown in Table 3. In the test, in a case where the evaluation of the dispersion stability is evaluation rank “C” or higher, the dispersion stability of the composition is excellent (the excellent initial dispersibility of the solid particles can be maintained for a long period of time), which is preferable.

### Example 2

In Example 2, each of the compositions produced in Example 1 was used to produce a solid electrolyte sheet for an all-solid state secondary battery and an electrode sheet for an all-solid state secondary battery, whereby an all-solid state secondary battery was manufactured.

### 1. Manufacture of All-Solid State Secondary Battery

Each of the above compositions (slurries) was used immediately after the preparation to produce a solid electrolyte sheet for an all-solid state secondary battery and an electrode sheet for an all-solid state secondary battery, which were subsequently used to manufacture each all-solid state secondary battery, which had a coating layer as the solid electrolyte layer and the active material layer immediately after the composition was produced, was produced as described later.

### Production of Negative Electrode Sheets Nos. N-1 to N-4 for All-Solid State Secondary Battery

Each of the compositions Nos. N-1 to N-4 for a negative electrode immediately after preparation, obtained as described above, was applied onto a copper foil having a thickness of 20 μm with the above-described baker type applicator (product name: SA-201 baker type applicator, manufactured by Tester Sangyo Co., Ltd.), and heating was carried out at the temperature shown in Table 2 for 1 hour to dry the composition for a negative electrode, thereby producing each of negative electrode sheets Nos. N-1 to N-4 for an all-solid state secondary battery, having a laminated structure of negative electrode active material layer/copper foil. The thickness of the negative electrode active material layer was 100 μm.

### Production of Positive Electrode Sheets Nos. P-1 to P-21 for All-Solid State Secondary Battery

Each of the compositions Nos. P-1 to P-21 for a positive electrode layer immediately after preparation was applied onto an aluminum foil having a thickness of 20 μm with an applicator (product name: SA-201 baker type applicator, manufactured by Tester Sangyo Co., Ltd.), and the composition for a positive electrode was dried at the drying temperature shown in Table 2 to produce each of positive electrode sheets Nos. P-1 to P-21 for an all-solid state secondary battery, having a laminated structure of positive electrode active material layer/aluminum foil. The thickness of the positive electrode active material layer was 100 μm.

### Production of Solid Electrolyte Sheets Nos. S-1 to S-4 for All-Solid State Secondary Battery

Each of the inorganic solid electrolyte-containing compositions Nos. S-1 to S-4 immediately after preparation was applied onto an aluminum foil having a thickness of 20 μm with an applicator (product name: SA-201 baker type applicator, manufactured by Tester Sangyo Co., Ltd.), and heating was carried out at the temperature shown in Table 2 for 1 hour to dry the inorganic solid electrolyte-containing composition, thereby producing each of positive electrode sheets Nos. S-1 to S-4 for an all-solid state secondary battery, having a laminated structure of solid electrolyte layer/aluminum foil. The thickness of the solid electrolyte layer was 30 μm.

A measurement was carried out according to the above-described method to measure the number of particulate regions (pieces/10 μm²) derived from the polymer binder contained in the solid electrolyte layer of the solid electrolyte sheet for an all-solid secondary battery, the positive electrode active material layer of the positive electrode sheet for an all-solid secondary battery, and the negative electrode active material layer of the negative electrode sheet for an all-solid secondary battery. The results are shown in Table 2.

### Binding Property Test (90° Peeling Test) of Solid Electrolyte Sheet for All-Solid State Secondary Battery and Electrode Sheet for All-Solid State Secondary Battery

Regarding the solid electrolyte sheet for an all-solid state secondary battery and the electrode sheet for an all-solid state secondary battery produced by using each composition produced in Example 1 immediately after preparation, the binding property of the solid electrolyte layer or the active material layer was evaluated.

Specifically, an average peeling force measured by using a tensile tester (ZTS-50N, manufactured by IMADA Co., Ltd.) when a tape (width: 1 cm, length: 5 cm, product name: polyimide tape, manufactured by Nitto Denko Corporation) was attached (bound by pressurization at a pressure of 0.1 MPa for 5 minutes) to the surface of the solid electrolyte layer or the active material layer of each sheet, and this tape was peeled off at a peeling speed of 100 mm/s or 30 mm/s and at an angle of 90° with respect to the surface of the solid electrolyte layer or the active material layer was adopted as the peel strength (unit: N/mm).

The measured peel strength was applied to the following evaluation standards, and the binding property of the solid electrolyte layer or the active material layer was evaluated. In the test, in a case where the peel strength is 0.1 N/mm or more (the evaluation levels A and B), the binding property of the solid particles in the solid electrolyte layer or the active material layer, and furthermore, the binding property between the active material layer and the collector can be said to be excellent. In the present invention, it is more preferable that the peel strength is 0.15 N/mm or more (the evaluation level A).

### Evaluation Standards of Present Test (Peeling Speed: 100 mm/s)

A: 0.15 N/mm or more

B: 0.10 N/mm or more and less than 0.15 N/mm

C: 0.05 N/mm or more and less than 0.10 N/mm

D: Less than 0.05 N/mm

### Evaluation Standard in the Related Art (Peeling Speed: 30 mm/s)

A: 0.15 N/mm or more

B: 0.10 N/mm or more and less than 0.15 N/mm

C: 0.05 N/mm or more and less than 0.10 N/mm

D: Less than 0.05 N/mm

TABLE 3

| | | | Binding property | | |
|---|---|---|---|---|---|
| | Initial | Dispersion | Standard of | Standard in | |
| No. | dispersibility | stability | present test | related art | Note |
| P-1 | A | A | A | A | Present invention |
| P-2 | D | B | D | B | Comparative Example |
| P-3 | A | A | A | A | Comparative Example |
| P-4 | D | A | D | C | Comparative Example |
| P-5 | C | A | C | A | Present invention |
| P-6 | A | A | A | A | Present invention |
| P-7 | C | A | C | A | Present invention |
| P-8 | A | A | A | A | Present invention |
| P-9 | B | A | B | A | Comparative Example |
| P-10 | B | A | B | A | Comparative Example |
| P-11 | C | A | C | A | Present invention |
| P-12 | D | A | D | B | Comparative Example |
| P-13A | D | A | D | B | Comparative Example |
| P-13B | D | A | D | B | Comparative Example |
| P-14 | A | A | A | A | Present invention |
| P-15 | D | B | D | B | Comparative Example |
| P-16 | C | A | C | A | Present invention |
| P-17 | C | B | B | B | Present invention |
| P-18 | D | B | A | A | Comparative Example |
| P-19 | A | A | C | B | Present invention |
| P-20 | A | A | A | A | Present invention |
| P-21 | A | A | A | A | Present invention |
| S-1 | D | C | D | C | Comparative Example |
| S-2 | B | A | C | B | Present invention |
| S-3 | A | A | A | A | Present invention |
| S-4 | A | A | A | A | Present invention |
| N-1 | D | C | D | A | Comparative Example |
| N-2 | B | A | B | A | Present invention |
| N-3 | A | A | A | A | Present invention |
| N-4 | A | A | A | A | Present invention |

### Manufacturing of Batteries for Evaluation of Negative Electrode Sheets (Nos. C-27 to C-30) for an All-Solid State Secondary Battery

Each of the produced negative electrode sheets for an all-solid state secondary battery was punched out into a disk shape having a diameter of 10 mm and placed in a cylinder made of polyethylene terephthalate (PET) and having an inner diameter of 10 mm. 30 mg of the LPS synthesized in Synthesis Example A was placed on the negative electrode active material layer side in the cylinder, and a stainless steel (SUS) rod having a diameter of 10 mm was inserted from the openings at both ends of the cylinder. The collector side of the negative electrode sheet for an all-solid state secondary battery and the LPS were pressurized by applying a pressure of 350 MPa with a SUS rod. “The SUS rod on the LPS side was once removed, and a disk-shaped indium (In) sheet having a diameter of 9 mm (thickness: 20 μm) and a disk-shaped lithium (Li) sheet having a diameter of 9 mm (thickness: 20 μm) were inserted in this order onto the LPS in the cylinder. The removed SUS rod was inserted again into the cylinder and the sheets were fixed while applying a pressure of 50 MPa. In this manner, an all-solid state secondary battery (a half cell) having a structure of copper foil (thickness: 20 μm)—negative electrode active material layer (thickness: 80 μm)—solid electrolyte layer (thickness: 200 μm)—counter electrode layer (In/Li sheet, thickness: 30 μm) was obtained.

### Manufacturing of Batteries for Evaluation of Positive Electrode Sheets (Nos. C-1 to C-22) for an All-Solid State Secondary Battery

Each of the produced positive electrode sheets for an all-solid state secondary battery was punched out into a disk shape having a diameter of 10 mm and was placed in a cylinder made of PET having an inner diameter of 10 mm. 30 mg of the LPS synthesized in Synthesis Example A was placed on the positive electrode active material layer side in the cylinder, and a SUS rod having a diameter of 10 mm was inserted from the openings at both ends of the cylinder. The collector side of the positive electrode sheet for an all-solid state secondary battery and the LPS were pressurized by applying a pressure of 350 MPa with a SUS rod. The SUS rod on the LPS side was once removed, and a disk-shaped Li sheet having a diameter of 9 mm (thickness: 20 μm) and a disk-shaped Li sheet having a diameter of 9 mm (thickness: 20 μm) were inserted in this order onto the LPS in the cylinder. The removed SUS rod was inserted again into the cylinder and the sheets were fixed while applying a pressure of 50 MPa. In this manner, an all-solid state secondary battery (a half cell) having a structure of aluminum foil (thickness: 20 μm)—positive electrode active material layer (thickness: 80 μm)—solid electrolyte layer (thickness: 200 μm)—counter electrode layer (In/Li sheet, thickness: 30 μm) was obtained.

### Manufacturing of Batteries for Evaluation of Solid Electrolyte Sheets (Nos.C-23 to C-26) for All-Solid State Secondary Battery

The positive electrode sheet (No. P-2) for an all-solid state secondary battery was punched out into a disk shape having a diameter of 10 mm and was placed in a cylinder made of PET having an inner diameter of 10 mm. Each solid electrolyte sheet for an all-solid state secondary battery produced on the positive electrode active material layer side in the cylinder was punched into a disk shape having a diameter of 10 mm and placed in the cylinder, and a 10 mm SUS rod was inserted from the openings at both ends of the cylinder. The collector side of the positive electrode sheet for an all-solid state secondary battery and the aluminum foil side of the solid electrolyte sheet for an all-solid state secondary battery were pressurized by applying a pressure of 350 MPa with a SUS rod. The SUS rod on the side of the solid electrolyte sheet for an all-solid state secondary battery was once removed to gently peel off the aluminum foil of the solid electrolyte sheet for an all-solid state secondary battery, and then a disk-shaped Li sheet (thickness: 20 μm) and a diameter of 9 mm and a disk-shaped Li sheet (thickness 20 μm) having a diameter of 9 mm were inserted in this order onto the LPS in the cylinder. The removed SUS rod was inserted again into the cylinder and the sheets were fixed while applying a pressure of 50 MPa. In this manner, an all-solid state secondary battery (a half cell) having a structure of aluminum foil (thickness: 20 μm)—positive electrode active material (80 μm)—solid electrolyte layer (thickness: 25 μm)—counter electrode layer (In/Li sheet, thickness: 30 μm) was obtained.

### Evaluation of Battery Performance (Cycle Characteristics)

Using the all-solid state secondary battery manufactured in “1. Manufacture of all-solid state secondary battery”, charging and discharging of 4.3 V to 3.0 V was carried out once (initialized) under the conditions of a charging current value of 0.13 mA and a discharging current value of 0.13 mA in an environment of 30° C.

Then, as the cycle test, charging and discharging of 4.3 V to 3.0 V was repeated under the same condition of a charging and discharging current value of 11.7 mA or 0.39 mA in an environment of 25° C. One time of charging and discharging is defined as one cycle.

In the charging and discharging at the same charging and discharging current value, the discharge capacity at the first cycle and the discharge capacity at the 20th cycle were measured, the discharge capacity retention rate was calculated according to the following expression, and this discharge capacity retention rate was applied to the following evaluation standards to evaluate the cycle characteristics of the all-solid state secondary battery.

In the test, the evaluation level of “C” or higher is the pass level at any charging and discharging current value.

Discharge capacity retention rate (%)=(discharge capacity at 20th cycle/discharge capacity at first cycle)×100

### Evaluation Standards of Present Test (Charging and Discharging Current Value: 11.7 mA)

AA: 80% or more and 100% or less

A: 70% or more and less than 80%

B: 60% or more and less than 70%

C: 50% or more and less than 60%

D: less than 50%

### Evaluation Standard in the Related Art (Charging and Discharging Current Value: 0.39 mA)

AA: 80% or more and 100% or less

A: 70% or more and less than 80%

B: 60% or more and less than 70%

C: 50% or more and less than 60%

D: less than 50%

### Evaluation of Battery Performance (Battery Resistance)

With respect to the battery after 20 cycles for the cycle characteristics at each charging and discharging current value, the impedance was measured at an amplitude of 10 mV and a frequency of 100 MHz to 1 MHz after adjusting the voltage to 3.8 V, and the reaction resistance was measured. In the test, “C” or higher is the pass level for any battery after the cycle test.

### Evaluation Standards of Present Test (After Cycle Test at Charging and Discharging Current Value of 11.7 mA)

A: Less than 20 Ω

B: 20 Ω or more and less than 30 Ω

C: 30 Ω or more and less than 40 Ω

D: 40 Ω or more

### Evaluation Standards in the Related Art (After Cycle Test at Charging and Discharging Current Value of 0.39mA)

A: Less than 20 Ω

B: 20 Ω or more and less than 30 Ω

C: 30 Ω or more and less than 40 Ω

D: 40 Ω or more

TABLE 4

| | Negative | | | Cycle | | Battery | | |
|---|---|---|---|---|---|---|---|---|
| | electrode | | Positive | characteristics | | resistance | | |
| | active | Solid | electrode | Standard | Standard | | Standard | |
| | material | electrolyte | active | of present | in related | Standard of | in related | |
| No. | layer | layer | material layer | test | art | present test | art | Note |
| C-1 | In/Li sheet | LPS | P-1 | B | A | B | A | Present invention |
| C-2 | In/Li sheet | LPS | P-2 | A | A | C | A | Comparative |
| | | | | | | | | Example |
| C-3 | In/Li sheet | LPS | P-3 | D | B | D | B | Comparative |
| | | | | | | | | Example |
| C-4 | In/Li sheet | LPS | P-4 | D | C | C | A | Comparative |
| | | | | | | | | Example |
| C-5 | In/Li sheet | LPS | P-5 | C | A | C | A | Present invention |
| C-6 | In/Li sheet | LPS | P-6 | A | A | A | A | Present invention |
| C-7 | In/Li sheet | LPS | P-7 | C | A | C | A | Present invention |
| C-8 | In/Li sheet | LPS | P-8 | A | A | A | A | Present invention |
| C-9 | In/Li sheet | LPS | P-9 | D | A | D | A | Comparative |
| | | | | | | | | Example |
| C-10 | In/Li sheet | LPS | P-10 | D | A | D | A | Comparative |
| | | | | | | | | Example |
| C-11 | In/Li sheet | LPS | P-11 | B | A | B | A | Present invention |
| C-12 | In/Li sheet | LPS | P-12 | D | A | D | A | Comparative |
| | | | | | | | | Example |
| C-13 | In/Li sheet | LPS | P-13A | D | B | D | A | Comparative |
| | | | | | | | | Example |
| C-14 | In/Li sheet | LPS | P-13B | D | C | D | C | Comparative |
| | | | | | | | | Example |
| C-15 | In/Li sheet | LPS | P-14 | A | A | A | A | Present invention |
| C-16 | In/Li sheet | LPS | P-15 | D | C | D | C | Comparative |
| | | | | | | | | Example |
| C-17 | In/Li sheet | LPS | P-16 | B | A | B | A | Present invention |
| C-18 | In/Li sheet | LPS | P-17 | C | A | B | A | Present invention |
| C-19 | In/Li sheet | LPS | P-18 | D | C | D | C | Comparative |
| | | | | | | | | Example |
| C-20 | In/Li sheet | LPS | P-19 | B | B | C | B | Present invention |
| C-21 | In/Li sheet | LPS | P-20 | A | A | A | A | Present invention |
| C-22 | In/Li sheet | LPS | P-21 | A | A | A | A | Present invention |
| C-23 | In/Li sheet | S-1 | P-2 | D | B | D | B | Comparative |
| | | | | | | | | Example |
| C-24 | In/Li sheet | S-2 | P-2 | B | A | C | A | Present invention |
| C-25 | In/Li sheet | S-3 | P-2 | A | A | B | A | Present invention |
| C-26 | In/Li sheet | S-4 | P-2 | A | A | A | A | Present invention |
| C-27 | N-1 | LPS | In/Li sheet | D | A | D | B | Comparative |
| | | | | | | | | Example |
| C-28 | N-2 | LPS | In/Li sheet | B | A | C | A | Present invention |
| C-29 | N-3 | LPS | In/Li sheet | A | A | B | A | Present invention |
| C-30 | N-4 | LPS | In/Li sheet | A | A | A | A | Present invention |

The followings can be seen from the results of Tables 2 to 4.

That is, the constitutional layer formed by using the inorganic solid electrolyte-containing composition of Comparative Example and the positive electrode active material layer, both of which do not contain the two kinds of polymer binders specified in the present invention, as well as the all-solid state secondary battery in which all the layers of the solid electrolyte layer and the negative electrode active material layer are layers or the like which do not contain the two kinds of polymer binders specified in the present invention, are inferior in any of the binding property, cycle characteristics, and battery resistance in the evaluation standard of the present test (denoted as “Standard of present test” in the table). Further, the inorganic solid electrolyte-containing composition of Comparative Example tends to be inferior in dispersibility.

On the other hand, the constitutional layer formed by using the inorganic solid electrolyte-containing composition according to the embodiment of the present invention, which contains the two kinds of polymer binders specified in the present invention, exhibits high binding property even in the evaluation standards of the present test. Further, the all-solid state secondary battery, in which the constitutional layer formed by using the inorganic solid electrolyte-containing composition according to the embodiment of the present invention is applied to at least one layer of the positive electrode active material layer, the solid electrolyte layer, or the negative electrode active material layer, has low battery resistance and exhibits excellent cycle characteristics even in the evaluation standards of the present test. Furthermore, the inorganic solid electrolyte-containing composition according to the embodiment of the present invention exhibits high dispersibility (initial dispersibility and dispersion stability).

In particular, in a case where the heating temperature of the inorganic solid electrolyte-containing composition during coating and drying (during the formation of the constitutional layer) is set to be equal to or higher than the crystallization temperature of the polymer binder B, it is possible to achieve both the lower resistance of the interfacial resistance of the constitutional layer to be obtained and the frim binding between the solid particles at a higher level.

### EXPLANATION OF REFERENCES

1: negative electrode collector

2: negative electrode active material layer

3: solid electrolyte layer

4: positive electrode active material layer

5: positive electrode collector

6: operation portion

10: all-solid state secondary battery

What is claimed is:

1. An inorganic solid electrolyte-containing composition comprising:
an inorganic solid electrolyte having an ion conductivity of a metal belonging to Group 1 or Group 2 in the periodic table; and
a polymer binder,
wherein the polymer binder includes at least two polymer binders A and B different from each other, where the polymer binder A has a particulate shape, and the polymer binder B is a polymer binder consisting of a polymer having a crystallization temperature of 60° C. or higher.

2. The inorganic solid electrolyte-containing composition according to claim 1, further comprising a dispersion medium.

3. The inorganic solid electrolyte-containing composition according to claim 2,
wherein the dispersion medium is a non-polar dispersion medium.

4. The inorganic solid electrolyte-containing composition according to claim 3,
wherein a solubility of the polymer binder B in the non-polar dispersion medium is 2% by mass or more.

5. The inorganic solid electrolyte-containing composition according to claim 3,
wherein a solubility of the polymer binder A in the non-polar dispersion medium is 1% by mass or less.

6. The inorganic solid electrolyte-containing composition according to claim 1,
wherein a polymer that forms the polymer binder B is a fluorine-based polymer, a hydrocarbon-based polymer, polyurethane, or a (meth)acrylic polymer.

7. The inorganic solid electrolyte-containing composition according to claim 1,
wherein a polymer that forms the polymer binder A is polyurethane or a (meth)acrylic polymer.

8. The inorganic solid electrolyte-containing composition according to claim 1, further comprising an active material.

9. The inorganic solid electrolyte-containing composition according to claim 8,
wherein a peel strength of the polymer binder B with respect to a collector is 0.1 N/mm or more.

10. A sheet for an all-solid state secondary battery, comprising a layer constituted of the inorganic solid electrolyte-containing composition according to claim 1.

11. The sheet for an all-solid state secondary battery according to claim 10,
wherein the layer constituted of the inorganic solid electrolyte-containing composition is a heat-dried product of the inorganic solid electrolyte-containing composition at a temperature equal to or higher than the crystallization temperature of the polymer binder B.

12. The sheet for an all-solid state secondary battery according to claim 10,
wherein the layer constituted of the inorganic solid electrolyte-containing composition contains 30 or more particulate regions derived from a polymer binder, in the cross-sectional region of 10 μm².

13. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is a layer constituted of the inorganic solid electrolyte-containing composition according to claim 1.

14. A manufacturing method for a sheet for an all-solid state secondary battery, the manufacturing method comprising forming a film by using the inorganic solid electrolyte-containing composition according to claim 1.

15. The manufacturing method for a sheet for an all-solid state secondary battery according to claim 14,
wherein the inorganic solid electrolyte-containing composition is heated at a temperature equal to or higher than the crystallization temperature of the polymer binder B.

16. A manufacturing method for an all-solid state secondary battery comprising the manufacturing method for a sheet for an all-solid state secondary battery according to claim 14.
